(19) United States
(12) Patent Application Publication
(10) Pub. No.: US 2017/0004571 A1
(43) Pub. Date: Jan. 5, 2017

(54) COMPUTERIZED METHOD OF LOCATING, COMMUNICATING AND PRIORITIZING PRIVATE PARTY TRANSACTIONS INVOLVING GOODS, SERVICES OR INFORMATION ABOUT GOODS OR SERVICES

(71) Applicant: Stuffmapper, SPC, Seattle, WA (US)

(72) Inventors: Benjamin Zuercher, Seattle, WA (US); Christine Deppe, Seattle, WA (US); Delaney Cunningham, Seattle, WA (US); Benjamin Patterson, Seattle, WA (US)

(21) Appl. No.: 15/201,081

(22) Filed: Jul. 1, 2016

Related U.S. Application Data
(60) Provisional application No. 62/188,644, filed on Jul. 4, 2015.

(51) Int. Cl. G06Q 30/08; H04L 29/08

(52) U.S. Cl. CPC G06Q 30/08; H04L 67/20; H04L 67/02

(57) ABSTRACT

Techniques are described facilitating transactions involving items or services or information about the items or services (“ISI”) and users. Sometimes, an automated ISI Transaction System coordinates ISI transactions by matching users with ISI with users demanding that ISI. The types of ISI involved may vary, but may include ISI such as clothing, furniture, electronics, books, tickets, video games, computer software, etc. The operation of the ISI system may be enhanced in various ways, including by selecting appropriate users to receive opportunities to sell or supply ISI available from those users, such as in a manner to balance supply and demand for ISI, and by notifying the selected users of those opportunities. The operation of the ISI system may also be enhanced by selecting appropriate users to receive available opportunities to buy or demand ISI such as in a manner to balance supply and demand for ISI.

### CROSS REFERENCE INFORMATION

This application claims priority to provisional application 62/188,644 filed Jul. 4, 2015.

### TECHNICAL FIELD

The following disclosure relates generally to facilitating transactional exchanges involving goods or services or information about goods or services.

### BACKGROUND

The Internet comprises a vast number of computers and computer networks that are interconnected through communication links, with access to information being provided using various services such as electronic mail (“email”) and the World Wide Web (also referred to as the “Internet” or the “Web”). In addition to providing access to information, the Internet has increasingly become a medium that is used to search for, shop for and order items (such as goods, services and/or information) that are for purchase, rent, lease, license, trade, evaluation, sampling, subscription to, etc. In many circumstances, a user can visit the Internet site of an Internet merchant (or an “Internet store”) or otherwise interact with an online retailer or electronic marketplace that provides one or more items or services, such as to view information about the items or services, give an instruction to place an order for one or more items or services, and provide information needed to complete the purchase (e.g., payment and shipping information). The Internet merchant then fulfills the order by providing the ordered items or rendering the service to the indicated recipient, such as by providing product items or services that have been ordered through physical distribution channels (e.g., shipment via a governmental postal service or private common carrier) or electronically (e.g., via download over the Internet, such as for digital music or videos) as appropriate. Ordered service items may similarly be provided electronically (e.g., providing email service) or physically (e.g., performing cleaning services at the purchaser's house).

Some Internet sites have arisen that allow users to sell items or services to and purchase items or services from each other, such as DVD movies, audio CDs, or video games. A user will typically register to become a customer by entering personal information, such as the user's name, mailing address and payment information. Once registered, the customer can interact with other customers to provide or receive items. For example, a customer may be able to specify items that (s)he would like to receive from others and/or items that (s)he is willing to provide to others. When a match between two customers is made for a particular item, the customer who has the item provides it to the other customer who would like to receive it, typically based on some form of compensation given to the customer providing the item (e.g., monetary payment, “points” or other form of credit tracked by the Internet site, etc.). Similarly, the customer who receives an item typically provides some form of compensation for receiving the item. The operator of such an Internet site may in some cases obtain revenue in various ways, such as by charging a fee for each item transaction, by charging a fee for membership, etc.

However, various problems exist with such Internet sites for facilitating transactions involving items or services between users or information about such items or services. One such problem results from difficulties in appropriately balancing user supply and demand for items or services or information about items or services. For example, if several users each demand a category or type of new or used item or service that is available from a number of other users, such Internet sites typically have difficulties in ensuring that the users who demand the item or service each receive the item, service or information about the item or service in a timely manner without notifying an excess number of the users who have the available item or service. If too few of the users who have the available item or service are notified (or if the notified users do not respond in a timely manner), then insufficient items, services or information about the items or services will be provided for the users who demand the items or services, resulting in customer dissatisfaction among the users who do not receive the items or services. Conversely, if too many of the users who have the available items or services are notified (e.g., all of them), many of the notified users will be unable to actually supply their items or services in response to the notification because other notified users have already met the demand for the item, resulting in customer dissatisfaction among those users. Also, if too many of the users who demand items or services or information about the items or services notify the users who have the available items or services or information about the items or services not all of the users who demand the items or services or information about the items or services will be notified if the supply of users who have the available items or services or information about the items or services cannot meet the demand of the users.

Another such example of the difficulty that Internet sites have in balancing user supply and demand for items or services or information about items or services exists when there is no supply for a user who demands an item or service or information about an item or service and there is no technique for notifying the user who demands an item or service or information about an item or service about the eventual supply for the item or service or information about an item or service the user is demanding.

Thus, it would be beneficial to provide techniques to facilitate transactions involving users that demand items or services or information about the items or services and users that supply the items or services or information about the items or services, as well as to provide other benefits.

### BRIEF DESCRIPTION OF THE DRAWINGS

FIG. 1 is a flow diagram illustrating an example embodiment of the functionality at a fundamental level depicting a type of successful transaction between a Lister and Looker or between a Lister and Pre-Dibs Looker. Note, in the preferred embodiment of the system, there would be multiple Listers, Lookers and Pre-Dibs Lookers.

FIG. 2 is a block diagram illustrating an example embodiment of an Items or Services or Information about the Items or Services (or “ISI”) transaction system capable of interacting with customers to provide the described techniques and the various sources that flow in and out.

FIG. 3A is a block diagram illustrating an overview of the ISI Transaction System at the macro level and FIGS. 3B-3E reference back to FIG. 3A and illustrate the various components—Collection of Computing Systems & Databases (In-House), Collection of Computing Systems & Databases (Third Party), System of Personal Network Devices & Databases, and Physical Dibs—of the ISI Transaction System at the macro level.

FIG. 4A is a block diagram illustrating an overview of the ISI Transaction System at the micro level and FIGS. 4B-4G reference back to FIG. 4A and illustrate the various types of users—Anonymous Lister, Anonymous Looker, Lister, Looker, Dibber, Pre-Dibs Physical Dibber, Physical Dibs Dibber, and Admin—who can interact with the ISI Transaction System.

FIG. 5 is a flow diagram illustrating an example embodiment which depicts an example successful transaction involving a couch between Bob, the Lister, and Susan, the Looker.

FIG. 6 is a flow diagram illustrating an example embodiment which depicts an example successful transaction involving a couch between Bob, the Lister, and Andy, the Pre-Dibs Looker.

FIG. 7A is a block diagram illustrating an example embodiment of an individual unit of available ISI's present features that are displayed on the user interface of a smartphone connected to the ISI Transaction System and a personal computer connected to the ISI Transaction System. FIG. 7B references back to FIG. 7A and illustrates an example embodiment of an individual unit of Dibbed (unavailable) ISI's present features that are displayed on the user interface of a smartphone connected to the ISI Transaction System and a personal computer connected to the ISI Transaction System.

FIG. 8A is a diagram illustrating an example embodiment of a sequential overview of the Dibs Process and the successful achievement of Full Dibs Functionality on a timeline between the events of activating the Dibs Button on an individual unit of ISI and the removal of that ISI from Active Inventory. FIG. 8B references back to FIG. 8A and illustrates an example embodiment of a sequential overview of the Dibs Process and the unsuccessful achievement of Full Dibs Functionality on a timeline between the events of activating the Dibs Button on an individual unit of ISI and the re-entry of that ISI back into Active Inventory.

### DEFINITIONS

ACTIVATE THE DIBS BUTTON (verb): A user may Activate the Dibs Button, or Activate Dibs, “Dib”, “to Dibs”, “Activate the Physical Dibs Button”, “Press the Dibs button” by clicking, tapping, squeezing, licking, pressing, signaling, pulling, hovering, pushing, hitting, or selecting a virtual button on a website or mobile app or physical button, known as “Dibs”. The button may be activated by hand, computer mouse, fingers, voice, light, device, or other methods common in the art. A device such as a smartphone may be hovered over a Physical Dibs button to activate the button via Near Field Communication, WiFi, or other type of connection.

ACTIVE INVENTORY (noun): Active Inventory, or “Active ISI”, is ISI or the collection of ISI that hasn't been Dibbed, and is available to be seen or Dibbed by anyone on the Platform.

ADMIN (noun): The Admin is a user type whose intent is to oversee and regulate the operations and users within the ISI Transaction System.

ANONYMOUS LISTER (noun): The Anonymous Lister, or “anonymous ISI-supplier”, is a user type who has the intent of using the Platform to do anything they are able to do without having to register an account or having to log in to their account. The Anonymous Lister would be interested in listing ISI via external marketing ISI or social media channels.

ANONYMOUS LOOKER (noun): The Anonymous Looker, or “anonymous ISI-demander”, is a user type who has the intent of using the Platform to do anything they are able to do without having to register an account or having to log in to their account. The Anonymous Looker would be interested in browsing the Platform for ISI, without having to log in or create an account.

API (noun): An API, or “Application Programmable Interface”, is a set of routines, protocols, and tools for building software applications. The API specifies how software components should interact and APIs are used when programming graphical user interface (GUI) components.

APP (noun): A self-contained program or piece of software designed to fulfill a particular purpose; an application, especially as downloaded by a user to a mobile device.

ATTRIBUTE (noun): An attribute is a keyword, tag, or category that a Lister may assign to the ISI they are listing to more clearly and succinctly describe and categorize the ISI they are posting. In another embodied case involving another type of user, the Pre-Dibs Looker would add an attribute(s) to their watchlist to be notified later if that ISI associated with their keyword becomes available.

Continuous Integration (noun): Continuous Integration, or “CI”, is a development practice that requires developers to integrate code into a shared repository several times a day; each check-in is then verified by an automated build, allowing teams to detect problems early.

DIBBED (adjective): Dibbed describes ISI that has been Dibbed by a Dibber. Furthermore, a user such as a Looker activated the Dibs button on ISI, and made the ISI Dibbed. ISI that is Dibbed is considered unavailable to all within the scope of the Dibs Process except to the Lister and the Dibber of the individual unit of ISI.

DIBBED (verb): Dibbed describes the past action a user such as a Looker did to activate Dibs on ISI. Moreover, the Looker activated the Dibs button on ISI, or Dibbed the ISI, and the Looker became the Dibber of the individual unit of ISI, and made the status of the particular ISI classified as Dibbed.

DIBBER (noun): The Dibber is a user type who has the intent of using the Platform to go through the Dibs Process to eventually receive Full Dibs Functionality to the method that grants them priority access to the ISI, or the ISI's location on a map, written address, have knowledge of its geographic coordinates, or other valuable information that is offered by the Platform. The Dibber also seeks exclusive communication privileges with the Lister or entity that offers the ISI for sale or donation. The Looker wants to activate the Dibs button to claim the ISI, and become the sole Dibber, which disallows the opportunity for all the other Lookers to activate or view a Dibs button on the same ISI. After activating the Dibs button, the Dibber must go through the Dibs Process. See the Dibs Process.

DIBBING (verb): Dibbing describes the present action a user such as a Looker does to activate Dibs on ISI. Moreover, the Looker activated the Dibs button on ISI, or Dibbed the ISI, and the Looker became the Dibber of the individual unit of ISI, and made the status of the particular ISI classified as Dibbed.

DIBS (noun): The function of claiming a priority right to a good or service or information about the good or service, as well as exclusive communication with the owner of the good or service or information about the good or service. “Dibs” may refer to the “Dibs Button” or the “Dibs Process” itself.

DIBS BUTTON (noun): The Dibs button appears on a graphical user interface next to listed ISI. The Dibs button is the button a Looker activates to begin the process of becoming a Dibber for a particular individual unit of ISI. Once activated, the Dibber (who was just a Looker a moment before they activated the button) is prompted to message or contact the Lister or appropriate entity via a messaging API and must message the Lister within a preset time frame in order to secure their privilege for the specified full time duration granted by the Dibs functionality. See “Full Dibs Functionality”.

DIBS LITE BUTTON (noun): The Dibs Lite button, or “Dibs Lite”, is like the Dibs button without the communication component. If Listers choose to List ISI that is unattended (or “Unattended ISI”) by them (i.e. on the curb, outside, out of their hands) and do not want to converse with a Dibber, they may do so with the Dibs Lite button. Listers who list ISI on the Platform that have a Dibs Lite button do not have accountability for their ISI. After they list their ISI they don't need to do anything, such as communicate with a Dibber.

DIBS LITE DIBBER (noun): The Dibs Lite Dibber is a user type whose intent is to be a Dibber by way of activating the Dibs Lite button with the goal of obtaining Unattended ISI. The only difference between a Normal Dibs Process and Dibs Lite Dibs Process is that the Dibs Lite Dibber can't get exclusive messaging with the Lister or entity associated with specific ISI. This is because there is no Lister on the other end to communicate with.

DIBS PRIVILEGES (noun): Dibs Privileges are the benefits that a Dibber gets after activating the Dibs button, such as priority access to ISI and exclusive communication with the Lister of the ISI.

DIBS PROCESS (noun): The Dibs Process encompasses everything that occurs from the instant an ISI's Dibs button is activated all the way to when the ISI is successfully exchanged. If ISI is successfully exchanged via the ISI Transaction System, the Dibs Process includes all the steps that make a successful transaction and exchange possible. Beyond the exchange of the ISI the Dibs Process also includes post-exchange tracking methods that may include rating the Dibber and Lister for the specific transaction. The Platform holds the Dibber and Lister accountable to know if the ISI has been successfully exchanged or not. This way, the Admin may know if ISI was removed from Active Inventory, based on the actions of the Dibber and Lister.

EXCHANGE (noun): Exchange, or “pickup”, is the act of collecting a person, animals, or goods.

FLAKE (noun): A flake is someone who commits to getting ISI but never shows up to pick up or exchange the ISI. For example, they may activate the Dibs button on ISI and/or message the Lister to coordinate the exchange of the ISI, but they never show up to pick up the ISI. In this situation, the fault rests with the Dibber, who is considered a flake. Using as a verb, the Dibber is considered to have flaked out. The Dibber who achieves Full Dibs Functionality status is considered a flake if they fail to exchange the ISI with the Lister during the Secondary Time Limit Phase. A Dibber can also flake after Dibbing ISI with the Dibs Lite button. A Lister can also flake out if they fail to exchange the item with the Dibber or post an ISI they do not have legal title to.

FULL DIBS FUNCTIONALITY (noun): Full Dibs Functionality is also referred to as “FDF”, “full privilege of priority access to ISI” (beyond preset time cutoff) or “full privilege to Dibs”. Full Dibs Functionality is the status that a Dibber seeks after activating the Dibs button. Once the Dibs button is activated, the Dibber must proceed with their responsibility to message or contact the Lister in order to secure the rest of their Dibs privileges, and achieve their Full Dibs Functionality. Moreover, once the Dibs button is activated a Dibber has a preset time opportunity, also known as the Pre-FDF Commit Phase, to initiate communication with the Lister of the ISI that they Dibbed. The Dibber achieves FDF the instant they initiate communication with the Lister via in-app messaging, for example. The Dibber seeks FDF and is motivated to initiate messaging before the Pre-FDF Commit Cutoff time or else they lose their privilege to Dibs that specific ISI. If the Dibber fails to initiate messaging or communication with the Lister and achieve FDF before their preset time opportunity (or Pre-FDF Commit. Cutoff) expires, they forfeit their opportunity to seek Full Dibs Functionality. If Dibber doesn't initiate communication with Lister of ISI before the Pre-FDF Commit Cutoff, the ISI and the ISI's respective Dibs button, location, and other exclusive information re-enter Active Inventory; if the ISI re-enters Active Inventory then the other Lookers and General Public can once again view and activate Dibs on that ISI.

GENERAL PUBLIC (noun): General Public refers to anyone who visits the Platform Associated with the ISI Transaction System. Also, in the case of Pre-Dibs, the General Public is comprised of users that did not have the attribute connected to specific ISI on their watchlists.

GOODS (noun): Goods are items such as clothing, furniture, electronics, books, tickets, video games, computer software, etc.

INACTIVE INVENTORY (noun): Inactive Inventory is the ISI or collection of ISI that has been Dibbed and its Dibs Button is thus inaccessible to all. Images, locations, and other information about ISI in Inactive Inventory may or may not still be accessible on the system to users other than the sole Dibber.

INFORMATION ABOUT ITEMS OR SERVICES (noun): Information about items or services is any information, data, recorded or collected notes or intelligence that is available about specific items or specific services.

INTERNET OF THINGS (noun): The Internet of Things, or “IoT”, is the proposed development of the Internet in which everyday objects have network connectivity, allowing them to send and receive data. Furthermore, the IoT is a network of physical objects or “things” embedded with electronics, software, sensors and connectivity to enable it to achieve greater value and service by exchanging data with the manufacturer, operator and/or other connected devices.

ISI (noun): ISI is items or services or information about the items or services. ISI may exist virtually, such as on a machine, or in the natural world in concrete form such as on a street curb or doorstep, inside a house or apartment, etc. ISI may sometimes be referred to as “stuff” or “inventory”. Examples of ISI may be a bicycle, a service that sells guidance on how to ride a bicycle, or information about a bicycle. Furthermore, the ISI may appear on a map or in a different form of data presentation, or it might appear out in the natural world.

ISI TRANSACTION SYSTEM (noun): The ISI Transaction System, or “ISI System,” makes possible the transactions, for example, between a Lister and a Looker or between a Lister and a Pre-Dibs Looker. There are at least eleven types of (human or nonhuman) users who can interact with the ISI Transaction System: Anonymous Lister, Anonymous Looker, Lister, Looker, Pre-Dibs Looker, Dibber, Pre-Dibs Physical Dibber, Physical Dibs Dibber, Dibs Lite Dibber, Physical Dibs Lite Dibber, and Admin. The ISI System executes on the In-House and/or Third Party Computer systems, which are connected to a Network (i.e. the Internet) and users' personal network devices such as smartphones, tablets, personal computers, or other devices, appliances, or machines. The ISI System may also connect to a Physical Dibs button. Primarily, the ISI System operates within or outside the framework of a website or mobile web application.

ITEMS (noun): Items are Goods.

LIST (verb): List has the same meaning as the noun of “post.”

LISTER (noun): The Lister, or “ISI-supplying user”, is a user type who is a seller or supplier of an item or service or information about item or service.

LISTING (noun): A Listing, or “Post”, contains the various elements of ISI they provide via the Platform such as description of ISI, image or video of ISI, attributes, etc. that the Looker will be able to view.

LOOKER (noun): The Looker, or “ISI-demanding user”, is a user type who is a potential buyer or demander of an item or service or information about the item or service.

LOOKING (verb): Looking, or “browsing”, is the action Lookers do when they explore the Platform for ISI they may demand.

NFC (noun): NFC, or “Near Field Communication”, is a set of ideas and technology that enables smartphones and other devices to establish radio communication with each other by touching the devices together or bringing them into proximity to a distance of typically 10 cm (3.9 in) or less.

NON-PHYSICAL EXCHANGE (noun): A non-physical exchange of ISI occurs virtually over the Internet involving software or ISI that can be sent virtually. It may include an exchange of payment through Internet between the private parties or there may be an exchange of pleasure resulting from laughs or exotic acting between the private parties such as in an internal or external video chat. ISI such as tickets may be sent through the Internet via the ISI Transaction System in a non-physical exchange, whereby the Dibber is emailed the tickets or receives the tickets via another type of virtual method. The Dibber Private Party and Lister Private Party may have others act on their behalf when exchanging the ISI.

NORMAL DIBS (noun): Normal Dibs is the same as Dibs, and anything relating to the Dibs Process that follows the activation of the Dibs button. Normal Dibs associates with the Normal Dibs Process that does not involve a Physical Dibs button.

NORMAL LOOKER (noun): The Normal Looker is the same as a Looker. The Normal Looker associates with the Normal Dibs Process that does not involve a Physical Dibs button.

NORMAL PHYSICAL DIBS (noun): Normal Physical Dibs is the same as Physical Dibs, and anything relating to the process that follows the activation of the Physical Dibs button.

PHYSICAL DIBS BUTTON (noun): The Physical Dibs button, or “Physical Dibs”, may be connected to a system that prints a ticket or receipt, emails a message or communicates a message in another manner. The Physical Dibs button may be connected to a system that signals or brings the next step of a process, such as giving out a code; the secret code or code might be a password, keyword, number, or something that enables the Dibber to have access to special offers or coupons or allow them to do the next step of a process before others who don't have the code. The Physical Dibs button interaction may also include the physical exchange of ISI with identification on the part of the ISI-demanding user. Like the Dibs button, the Physical Dibs button awards the Physical Dibs Dibber priority access to the geographic and written location of ISI as well as exclusive communication with the Lister or entity.

PHYSICAL DIBS DIBBER (noun): The Physical Dibs Dibber is a user type whose intent is to go through the Dibs Process to eventually receive Full Dibs Functionality to the method that grants them priority access to the location of ISI on a map or in written form as well as exclusive communication privileges with the Lister or entity that offers the ISI for sale or donation.

PHYSICAL DIBS LITE BUTTON (noun): The Physical Dibs Lite Button, or “Physical Dibs Lite”, is like the Dibs Lite button but involves a Physical Dibs button.

PHYSICAL DIBS LITE DIBBER (noun): The Physical Dibs Lite Dibber is a user type whose intent is to be a Physical Dibs Dibber by way of activating the Physical Dibs Lite button with the goal of obtaining Unattended ISI. The only difference between a Normal Physical Dibs Process and Physical Dibs Lite Dibs Process is that the Physical Dibs Lite Dibber can't get exclusive messaging with the Lister or entity associated with specific ISI. This is because there is no Lister on the other end to communicate with.

PHYSICAL EXCHANGE (noun): A physical exchange of ISI occurs when two private parties meet in-person to exchange ISI. A Dibber, for example, drives to Lister's house to pick up the ISI from Lister's porch while the Lister isn't home. Or the Dibber and Lister may meet at a public location such as a police station or public park to exchange ISI. Physical Exchange of ISI typically involves items or material goods. It may involve an in-person meeting between the demander and supplier or it may only require the Dibber, to arrive at the location of the ISI for the pickup of ISI. In another situation, the supplier, or Lister, may send the Dibber their ISI via mail or other physical courier means. The Dibber Private Party and Lister Private Party may have others act on their behalf when exchanging the ISI.

PICKED UP (verb): Picked up, or “exchanged”, is the action of ISI having been collected or received by the Dibber.

PLATFORM (noun): The Platform, or “System”, is the website, mobile app, application, button, or other that is connected to the ISI Transaction System.

PLATFORM ASSOCIATED WITH THE ISI TRANSACTION SYSTEM (noun): The Platform Associated with the ISI Transaction System is the website, mobile app (native or web app); application, button, or other that is connected to the ISI Transaction System.

POST (noun): The noun of post has the same meaning as “listing.”

POST (verb): Post, or “List”, is the action the Lister takes when committing to send their ISI to the Platform when they are ready for it to be seen by Lookers.

PRE-DIBS (noun): Pre-Dibs, or “Pre-Dibs Functionality”, is the method and opportunity that a Pre-Dibs Looker or Pre-Dibs Physical Looker has to participate in. Pre-Dibs allows Lookers to inform the ISI Transaction System that they demand specific ISI before it is supplied. The Pre-Dibs Looker assigns attributes, or keywords, to their watchlist within the Platform that relate to types of ISI, of which they want to be notified if that ISI becomes available. If ISI becomes available that relates to the keywords input into the user's watchlist, the Pre-Dibs Looker will be notified before users who didn't have the keywords in their watchlist and have a preset time opportunity to activate Dibs on the ISI before the Normal Lookers. The Pre-Dibs Functionality gives users who use the watchlist feature an advantage over users who do not (users who didn't enter the same or similar ISI-related keywords into their watchlist on the Platform) because at the time specific ISI enters into the supply the qualified users of Pre-Dibs are informed earlier than the non-qualified Pre-Dibs users or users who do not use Pre-Dibs, and they have a preset time opportunity to activate Dibs on the ISI before the others even know it is available.

PRE-DIBS ACTIVE INVENTORY (noun): Pre-Dibs Active Inventory is ISI or the collection of ISI that is available to be Dibbed on by Pre-Dibs Lookers. Other users may or may not be able to see images or other information about the ISI but the Dibs button would be greyed out or inaccessible to these users.

PRE-DIBS INACTIVE INVENTORY (noun): Pre-Dibs Inactive Inventory is ISI or the collection of ISI that has been Dibbed on by a Pre-Dibs Looker. The Dibs button is now greyed out or inaccessible to all. Users other than the sole Dibber may or may not have access to images or other information about the ISI.

PRE-DIBS LOOKER (noun): The Pre-Dibs Looker is a user type who demands specific ISI before it is supplied. The Pre-Dibs Looker assigns attributes, or keywords, to their watchlist within the Platform that relate to types of ISI, of which they want to be notified if that ISI becomes available. If ISI becomes available that relates to the keywords input into the user's watchlist, the Pre-Dibs Looker will be notified before users who didn't have the keywords in their watchlist and have a preset time opportunity to activate Dibs on the ISI before the Normal Lookers.

PRE-DIBS PHYSICAL LOOKER (noun): The Pre-Dibs Physical Looker is a user type whose intent is like that of the Pre-Dibs Looker but with a Physical Dibs button and has a preset time opportunity to activate the Physical Dibs button on the ISI. Just before the moment they start the process to becoming a Physical Dibs Dibber, the Pre-Dibs Physical Looker activates the Dibs button. The Pre-Dibs Physical Looker is someone or something that demands specific ISI before it is supplied. The Pre-Dibs Physical Looker assigns attributes, or keywords, to their watchlist within the Platform that relate to types of ISI, of which they want to be notified if that ISI becomes available. If ISI becomes available that relates to the keywords input into the user's watchlist, the Pre-Dibs Physical Looker will be notified before users who didn't have the keywords in their watchlist and have a preset time opportunity to activate Dibs on the ISI before the Normal Lookers.

PRE-FDF COMMIT CUTOFF (noun): The Pre-FDF Commit Cutoff, or the “Pre-FDF Cutoff”, is the instant in time that affords the Dibber Full Dibs Functionality if the Dibber qualifies. Or, if the Dibber failed to initiate communication with the Lister during the Pre-FDF Commit Phase before the Pre-FDF Cutoff time, the Dibber loses their Dibs privilege and the ISI they Dibbed returns to Active Inventory. The Pre-FDF Cutoff is a cutoff time imposed and required by the ISI Transaction System with the intent of motivating the Dibber to prove they are interested in completing the transaction and exchange of ISI. It's a precaution the ISI Transaction System takes to vet out flakes, or users who don't take the transactions seriously.

PRE-FDF COMMIT PHASE (noun): The Pre-FDF Commit Phase is also referred to as the “Pre-Full Dibs Functionality Commit” or “Pre-FDF Commit”. The Pre-FDF Commit is the window of time that occurs between the activation of the Dibs button and the Pre-FDF Commit Cutoff Time. If Dibber fails to initiate messaging with Lister during this phase, the Dibber loses their Dibs privilege and the ISI they Dibbed returns to Active Inventory.

PRESET TIME OPPORTUNITY (noun): Preset Time Opportunity is the same as the “Pre-FDF Commit Phase”.

PRIVATE PARTIES (noun): A Private Party may be a user, such as a Lister and Looker, who has an account and is logged in to the Platform. A Private Party may also be a person, business, or other entity that uses Dibs for games, profit, or any other activity. For example, a business may use the Platform associated with the ISI Transaction System to plant their items or codes in a scavenger hunt or marketing/sales initiative.

POST-DIBS TRACKING (noun): Post-Dibs Tracking is the ISI Transaction System's automated tracking that occurs between the time when the user activates the Dibs button and the Post-FDF Cutoff Time, when the ISI is exchanged. The ISI Transaction System communicates with the Lister and Dibber by sending them push notifications, in-app messages, or other methods common in the art that enable the Platform to confirm if the ISI has been exchanged. Post-Dibs Tracking is also used to study the behavior of the Lister and Dibber in each ISI transaction after the activation of the Dibs button to better learn how to make improvements to the Platform.

POST-EXCHANGE TRACKING (noun): Post-Exchange Tracking is the ISI Transaction System's automated tracking that occurs between the Post-FDF Cutoff Time, when the ISI is exchanged between the Lister and Dibber, and indefinitely into the future. The ISI Transaction System communicates with the Lister and Dibber by sending them push notifications, in-app messages, or other methods common in the art that enable the Platform to confirm if the ISI has been exchanged. After the exchange occurs, the Platform may continue to send push notifications, in-app messages, or other methods common in the art that enable the Platform more opportunities to confirm if the ISI has been exchanged, why it was not exchanged, or probe the Lister and Dibber for information regarding their transaction. Post-Exchange Tracking is also used to study the behavior of the Lister and Dibber in each ISI transaction after the Post-FDF Cutoff Time to better learn how to make improvements to the Platform.

POST-FDF CUTOFF TIME (noun): The Post-FDF Cutoff Time, or “Post-FDF Cutoff”, marks the point in time by when a Dibber (who has achieved Full Dibs Functionality) must exchange the ISI with the Lister (or be branded a flake). The Post-FDF Cutoff Time concludes the Secondary Time Limit Phase.

PUSH NOTIFICATION (noun): Push notifications let the Platform notify a user of new messages or events even when the user is not actively using the Platform. On some devices, when a device receives a push notification, the application's icon and a message appear in the status bar.

SECONDARY TIME LIMIT PHASE (noun): The Secondary Time Limit Phase or “Secondary Time Limit”, describes the window of time and opportunity—afforded to the Dibber who achieves Full Dibs Functionality—between the Pre-FDF Cutoff moment and the moment the exchange of ISI occurs, between Dibber and Lister. FDF exists within the definition of Secondary Time Limit Phase but also includes the extra time the Dibber is afforded between the moment the Dibber initiates communication with the Lister and the Pre-FDF Cutoff Time. The Secondary Time Limit Phase's duration may be indefinite or have a Post-FDF Cutoff Time, which marks a point in time by when a Dibber must exchange the ISI with the Lister. The Post-FDF Cutoff Time's implementation or applicability may be determined by the Admin, and the Lister may suggest or set a window of time and Post-FDF Cutoff Time that the Dibber has to operate within.

SERVICES (noun): Services may be intangible products such as accounting, banking, cleaning, consultancy, education, insurance, expertise, medical treatment, transportation, software processes, cam videos, or other. Sometimes services are difficult to identify because they are closely associated with a good; such as the combination of a diagnosis with the administration of a medicine. No transfer of possession or ownership takes place when services are sold, and they cannot be stored or transported, are instantly perishable, and come into existence at the time they are bought and consumed.

UNATTENDED ISI (noun): Unattended ISI is ISI that is not attended by the Lister, who takes no responsibility for communicating or coordinating the exchange of the ISI since the moment they List their ISI (the ISI is out of their hands and the Lister is not accountable for their listed ISI). Unattended ISI may appear on the curb, sidewalk, driveway, in nature, outer space, underwater, outside a public or private residence, inside a residence or commercial area, or elsewhere. Unattended ISI is commonly associated with the Dibs Lite button or Physical Dibs Lite button.

UNDIBS (verb): A Dibber may unDibs, or deactivate, the Dibs on the ISI they previously Dibbed, which makes the ISI re-enter Active Inventory and available again to the General Public. If the Dibber also flakes the Lister may in effect unDibs the ISI for the Dibber by rejecting the Dibber's Dibs. A Dibber who unDibs their ISI relinquishes their Dibs privileges.

UNDIBBED (noun): ISI that has been unDibbed is ISI that has had its Dibs removed and has been returned to Active Inventory. Hence its Dibs button has been reactivated.

USERS (noun): Any individual or group that accesses the system in any form is a User. Listers, Dibbers, Lookers, and Admin are all non-limiting examples of Users.

VoIP (noun): VoIP, or “Voice over Internet Protocol”, is a form of technology that allows for speech communication via the Internet.

WATCHLIST (noun): The watchlist is what users of the Pre-Dibs feature, for example the Pre-Dibs Looker or Pre-Dibs Physical Looker, use to add their attributes, or keywords. If specific ISI enters into Active Inventory (the supply), the users who added the attributes to their watchlist that relates to that specific ISI entering Active Inventory (the supply), are notified before other users.

WEBSITE: A location connected to the Internet that maintains one or more pages on the World Wide Web.

### DETAILED DESCRIPTION

Techniques are described for facilitating transactions involving users and items or services or information about the items or services in various ways. In some embodiments, the item transactions are coordinated by an automated Items or Services or Information about the Items or Services (or “ISI”) transaction system provided via one or more computing systems, such that users of the ISI system who have available items are matched with other users of the ISI system who demand those items. By matching users, item transactions may occur via the ISI system. For example, the ISI system may engage in a sales transaction to sell the same purchased ISI to a user who demands the ISI. In at least some embodiments, transactions involving users and ISI are facilitated by selecting appropriate users to receive opportunities to sell or buy ISI available from those users, such as in a manner to balance supply and demand for items, and by notifying the selected users of those opportunities, as described in greater detail below. ISI may exist virtually, such as on a machine, or in the natural world in concrete form such as on a street curb or doorstep, inside a house or apartment, etc. ISI may sometimes be referred to as “stuff” or “inventory”. Examples of ISI may be a free bicycle, a bicycle for sale, a service that sells guidance on how to ride a bicycle, or information about a bicycle. Furthermore, the ISI may appear on a map or in a different form of data presentation, or it might appear out in the natural world.

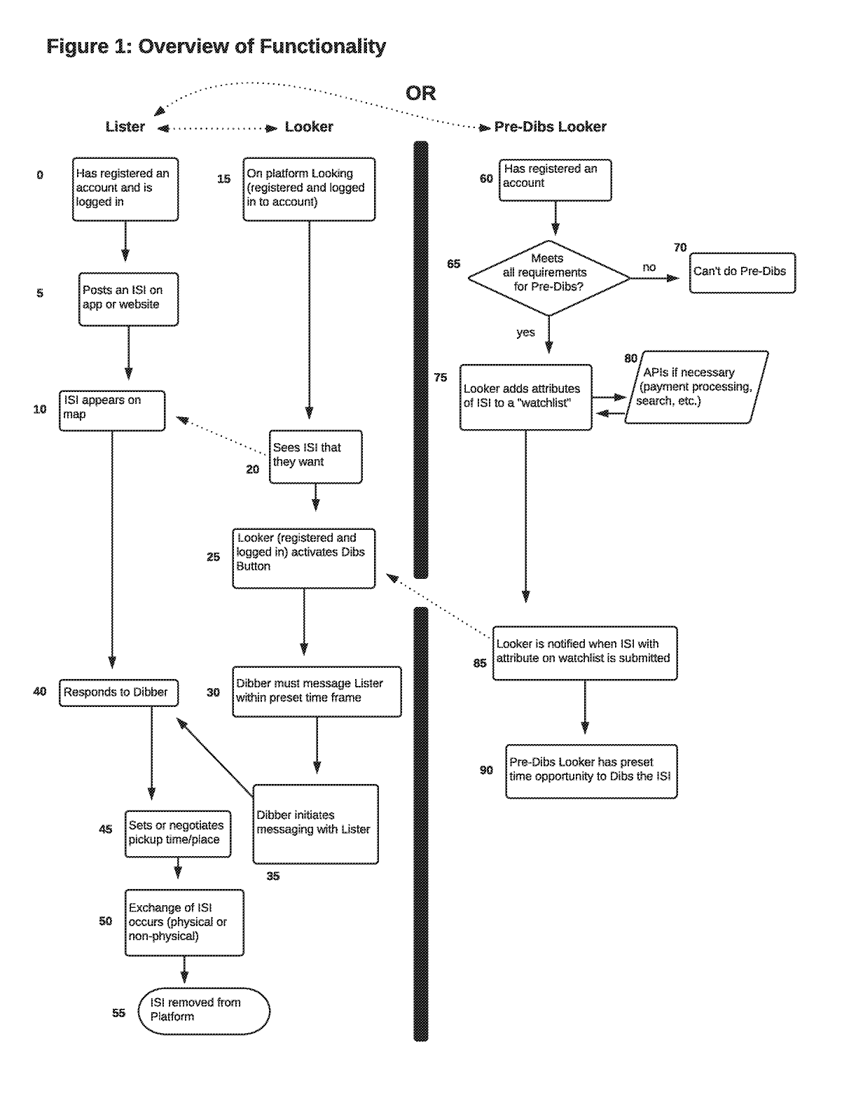

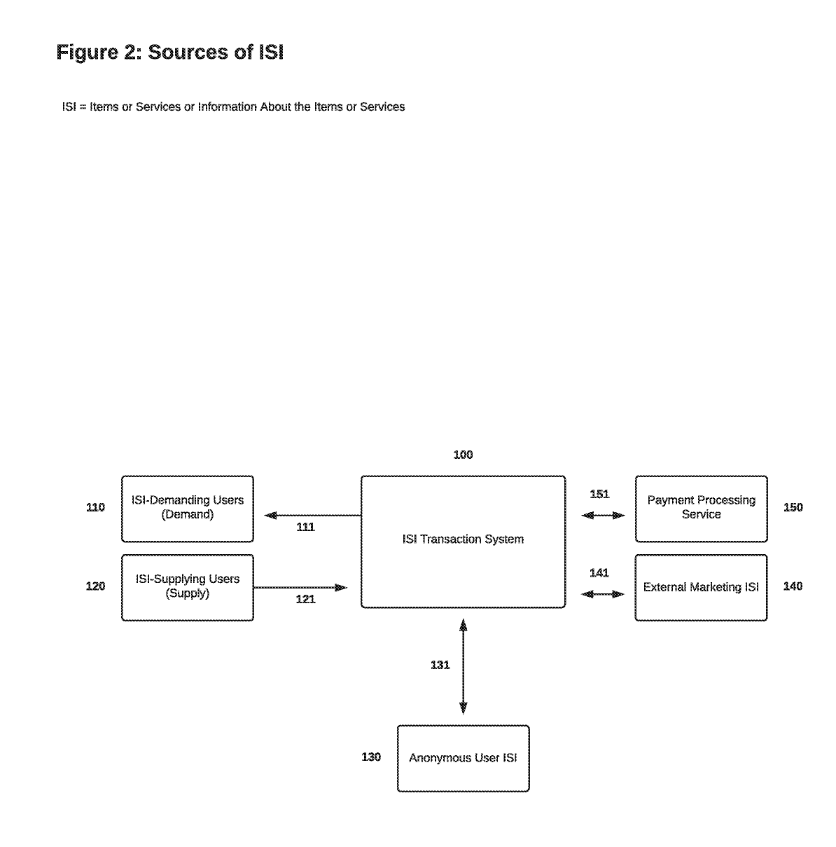

FIG. 1 is a flow diagram of an example embodiment of the functionality at a fundamental level depicting a type of successful transaction between a Lister and Looker or between a Lister and Pre-Dibs Looker. The ISI Transaction System makes such example transactions between the Lister and Looker or between the Lister and Pre-Dibs Looker possible. Although there are at least eleven types of (human or nonhuman) users—Anonymous Lister, Anonymous Looker, Lister, Looker, Pre-Dibs Looker, Dibber, Pre-Dibs Physical Dibber, Physical Dibs Dibber, Dibs Lite Dibber, Physical Dibs Lite Dibber, and Admin—who can interact with the ISI system, this drawing depicts two exclusive transactions between a Lister and Looker or between a Lister and Pre-Dibs Looker.

In this example involving a Lister and Looker, the Lister has registered an account and is logged in 0 on mobile app or website or other that is connected to platform associated with ISI Transaction System (or “Platform”). For a user to log in, such as the Lister and Looker, they must first create an account on Platform by providing requested information such as a username, password, phone number, and email address. After their account is set up the user must confirm their account by confirming that their email address or phone number is valid by responding to a message from the Platform, sent to their email or phone. Once their account is confirmed, the Lister and Looker may return to the Platform (i.e. website or mobile app) and log in or sign in to their just-created account by providing their email address or username and their password. Once they log in with their required valid credentials, the Lister and Looker, or other type of user, is ready to proceed. The Lister is someone or something that has ISI to provide to others, known as Lookers or Pre-Dibs Lookers. To do so the Lister provides an image or video of the ISI on app or website 5, location of the ISI via an Application Programmable Interface (or “API”) that has to do with maps, description of the ISI, and can categorize the ISI by assigning attribute(s); an attribute is like a keyword, tag, or category that the Lister may assign to the ISI they are listing to more clearly and succinctly describe and categorize the ISI they are posting. They may even suggest or select a range of time that they will be available to later transfer their ISI. After the Lister provides the information about the ISI they activate a button (a virtual button on a screen that the user activates by clicking with their computer mouse or tapping with their finger or other methods common in the art; the button that posts ISI relies on systems associated with the Platform such as In-House and Third-Party Computer Systems and Databases and Personal Network Devices) that posts their ISI they want to provide and the ISI is shown on the map 10 or elsewhere on the Platform. Meanwhile, the Looker 15 is someone or something that demands ISI at the same time the ISI is supplied, is looking for ISI (in this case the very same ISI that was just made available by the Lister), and they search for the ISI using an API for maps and an API for search. The Looker sees the ISI 20 that they want, which happens to be the same ISI the Lister just listed and appeared on the map 10. Registered and logged into their account, the Looker activates the Dibs button 25 and becomes a Dibber. A user may activate the Dibs button by clicking, tapping, squeezing, licking, pressing, signaling, pulling, hovering, pushing, hitting, or selecting a virtual button on a website or mobile app or physical button, known as “Dibs”. The button may be activated by hand, computer mouse, fingers, voice, light, device, or other methods common in the art. A device such as a smartphone may be hovered over a Physical Dibs button to activate the button via Near Field Communication, WiFi, or other. Furthermore, for example, a Looker may be on the Platform on their personal computer and they may point their computer mouse and click the Dibs button to activate Dibs. Or, using their smartphone or tablet computer the Looker may tap their finger on the Dibs button to activate Dibs. The Normal Dibs button typically appears on a screen and is manifested in pixel-form whereas the Physical Dibs can take any shape or form, such as a ball, square prism, or other three-dimensional shape. The Dibs function grants the Looker the ability to be a Dibber and have priority access to the ISI's location and exclusive messaging with the Lister to coordinate details concerning the final transaction of the ISI. After activating the Dibs button the Dibber is prompted to message Lister or appropriate entity and must message the Lister within a preset time frame 30 in order to secure their privilege for the specified full time duration granted by the Dibs functionality; there may or may not be a time constraint beyond the preset time frame in which the Lister must make first contact with the Lister, usually via in-app messaging. Once the Dibber initiates messaging with Lister 35 or appropriate entity via messaging API, email API, SMS API, and other methods common in the art, the Lister responds to Dibber 40 via messaging API. There isn't a specific required response for the Dibber beyond doing something that starts a conversation with the Lister; the Dibber may simply initiate communication with the Lister by sending an emoticon such as “ [symbol] ”. Now connected, the Lister and Dibber set or negotiate time/place 45 and other details concerning the pickup of the ISI. Finally, there occurs a physical exchange (i.e. two private parties meet in-person to exchange ISI or Dibber Private Party drives over to Lister's house to pick up the ISI from their porch while they aren't home) or non-physical exchange (i.e. virtual exchange over the Internet involving software or ISI that can be sent virtually or exchange of payment through Internet between the private parties or there may be an exchange of pleasure resulting from laughs or exotic acting between the private parties such as in an internal or external video chat) of the ISI 50 before the ISI is removed from the Platform 55 so it's no longer viewable or available through the Platform to anyone that demands (or supplies) that very ISI in the public domain. Active Inventory is ISI or the collection of ISI that hasn't been Dibbed, and is available to be seen or Dibbed by anyone on the Platform. Once an ISI has been Dibbed, it is placed in Inactive Inventory. Inactive Inventory consists of ISI that have been Dibbed on. Thus, the geographic location, written address, Dibs button, geographic coordinates, or any data or information about ISI may be removed from the map or anywhere visible elsewhere on the Platform associated with the ISI Transaction System once the ISI has been Dibbed on and placed in Inactive Inventory. It's important to note that Administrators, or Admins, may still be able to view the information about the ISI, as they are not directly involved with the transaction of the ISI. Put another way, the ISI might still be visible on Platform but the Dibs button (and ability to activate Dibs) associated with the already Dibbed ISI is unavailable, inactive, or not visible to Lookers or others who may want to activate the Dibs button on already Dibbed ISI that has been placed in Inactive Inventory.

As previously noted, within this figure also exists a possible transaction between a Lister and a Pre-Dibs Looker, whereby the Pre-Dibs Looker is someone or something that demands specific ISI before it is supplied. The Pre-Dibs Looker has a registered account 60 and also meets other requirements for access to Pre-Dibs Functionality 65 (such as paid subscription or elevated level of trust) or they can't participate in Pre-Dibs 70. The Looker then adds attributes 75, also known as categories or tags, to a watchlist, which uses a payment processing API if watchlist is a paid feature, a search API 80, or other. When a Lister suddenly lists (or posts) an ISI that they listed with the same or similar attribute that the Pre-Dibs Looker committed in their watchlist, the Pre-Dibs Looker is notified 85 via messaging API, email API, SMS API, and other methods common in the art when ISI with attribute on watchlist is submitted. Once notified, the Pre-Dibs Looker has a preset time opportunity to activate the Dibs button on the ISI before the General Public, or users that did not have the attribute on their watchlists 90; furthermore, in the Pre-Dibs scenario, this does not mean that other users cannot see the ISI. They just can't activate the Dibs button on the ISI unless they are in a paid tier or some form of subscription. ISI, or a collection of ISI, that can only be Dibbed on by Pre-Dibs Lookers is considered to be in Pre-Dibs Active Inventory. That ISI may, after a set time, go into Active Inventory where they can be Dibbed on by all Lookers. ISI that have been Dibbed on by Pre-Dibs Lookers are moved to Pre-Dibs Inactive Inventory. Now both Pre-Dibs Lookers and Lookers cannot activate the Dibs button for the ISI, though some aspects of the ISI might still be visible on the Platform.

Once the Pre-Dibs Looker decides they are interested in the ISI that was triggered by their watchlist, they choose to activate the Dibs button 25 and become a Dibber. The Dibs function grants the Pre-Dibs Looker the ability to be a Dibber and have priority access to the ISI's location and have exclusive messaging with the Lister to coordinate details concerning the final transaction of the ISI. After activating the Dibs button the Dibber is prompted to message Lister or appropriate entity via a messaging API and must message the Lister within a preset time frame 30 in order to secure their privilege for the specified full time duration granted by the Dibs functionality (also known as achieving “Full Dibs Functionality”). Once the Dibber initiates messaging with Lister 35 or appropriate entity via messaging API, email API, SMS API, and other methods common in the art, the Lister responds to Dibber 40 via messaging API. Now connected, the Lister and Looker set or negotiate time/place and other details concerning the (physical or non-physical) exchange or pickup of the ISI 45. Finally, there occurs a physical or non-physical exchange of the ISI 50 before the ISI is removed from the Platform 55 so it's no longer viewable to anyone that demands that very ISI.

If either the Dibber or the Lister flake the ISI can be moved out of either Pre-Dibs Inactive Inventory or Inactive Inventory and moved to either Pre-Dibs Active Inventory or Active Inventory respectively. This means the Dibs button would be reactivated and the ISI would be available for other individuals to Dibs on.

FIG. 2 illustrates an example of an environment in which an embodiment of the ISI system may operate. In this example the ISI system is illustrated as an ISI Transaction System 100 executing on one or more computing systems (not shown). The ISI system 100 facilitates transactions involving ISI and users who are customers of the ISI system, and in particular facilitates transactions in which ISI is sent from various ISI-demanding users 110 to various ISI-supplying users 120. The types of ISI involved in transactions via the ISI system may vary, and in some embodiments may include virtual or physical ISI of one or more item types such as articles of clothing, furniture, electronics, books, rare collectibles, tickets, parking spot, special offers or discounts, coupons, junk, mounds of dirt, computer hardware, scrap metal, cooking utensils, appliances, video games, computer software, DVDs, music CDs, garden supplies, equipment, etc. or specific services or information about the items or services.

Transactions between customers of the ISI system may be initiated in various ways. For example, after an ISI-demanding user, or Looker, makes a request 111 to the ISI system—by activating the Dibs button—for priority access to a copy of an indicated item or service or information about an item or service, the ISI system may determine whether one or more ISI-supplying users, or Listers, have indicated that they have a copy of the requested item available. If so, the ISI system in this example notifies one of the ISI-supplying customers 121 on behalf of the ISI-demanding customer by connecting the two participants in an exclusive communication (i.e. via in-app messaging or other methods common in the art) experience. At the same time the ISI system enables the transaction of the copy of the ISI to the ISI-demanding user by prioritizing and transacting the sale of the geographically positioned item or service or information about the item or service based on the ISI-demanding user's subsequent action; the ISI-demanding user has a preset time to act and proactively message or signal the ISI-supplying user in order to preserve their exclusive privilege to interact and concert the final transaction of ISI. Lastly, the ISI system geographically hides the ISI and/or the ISI's Dibs button from other ISI-demanding users who were not the first to activate the Dibs button by moving the ISI to Inactive Inventory. Those who did not activate the Dibs button miss out on the opportunity to transact the ISI because they did not act fast enough to become the primary and sole Dibber; there is only one Dibber per unit of ISI at a time and it is the Dibber who is afforded priority access to ISI and exclusive communication with the ISI-supplying user and the knowledge of where that ISI-supplying user's listed ISI exists on Platform on map or elsewhere in its raw, written address or geographic coordinates. Furthermore, once the ISI is Dibbed, the Platform makes that ISI's Dibs button, location on map, written address, coordinates, or other information invisible, inactive, or unavailable to anyone or anything who/that isn't the Dibber and the Lister for the transaction by moving the ISI to Inactive Inventory. For example, before the individual unit of listed ISI was Dibbed it was located in Active Inventory, and the ISI's image, video, description, Dibs button, written-out address, and/or location is visible on the map of the Platform or elsewhere in the user interface. After the ISI was Dibbed, the ISI's image, video, and description is visible to Lookers and others but the ISI's Dibs button, written-out address and/or location is no longer visible, or accessible. It is inactive or is unavailable on the Platform's map or elsewhere in the user interface.

In this example, anonymous user ISI 130 exists when ISI-suppliers and ISI-demanders do not have accounts or are not logged in when using the ISI system 131. An anonymous ISI-demander may use the ISI system by browsing while an anonymous ISI-supplier may use the ISI system by listing ISI via an external marketing ISI 140. Social Media websites or platforms designed specifically for the purpose of connecting people through the Internet include Twitter's software and APIs, sold under the trademark “Twitter, Inc.” and Facebook's software and APIs, sold under the trademark “Facebook, Inc.”. For example, an anonymous supplier might list something via an API to a social media website—such as Twitter or Facebook and bypass the necessity to formally log in to the ISI system 141. Similarly, an anonymous ISI-demander might see a post of ISI on a social media website (such as Twitter or Facebook) and know the existence of that ISI because of the ISI Transaction System being connected to the outside websites or social media platforms.

In some embodiments, the ISI system may first verify that the ISI-supplying customer is willing to supply or sell the copy of the ISI. For example, if an ISI-demanding customer indicates to the ISI Transaction System that they are interested in the opportunity to receive or buy a copy of the ISI from a specific ISI-supplying customer, it is up to the ISI-demanding customer to be the first to instigate a conversation or relationship with the ISI-supplying customer via a method provided or promoted by the ISI system—such as in-app messaging, text messaging, instant messaging, SMS, MMS, telephone, email, etc.—within a preset time frame after the ISI-demanding customer activates the Dibs button. If the ISI-supplying customer determines that the ISI-demanding customer is unable to complete the transaction for any reason the ISI-supplying customer has the ability to reject the ISI-demanding customer and make available their ISI to the General Public by rejecting their Dibs; if a rejection happens, the ISI returns to the Active Inventory, or active ISI, available to be seen by anyone. Once connected and once the ISI-supplying customer and ISI-demanding customer agree on the nature of the potential final transaction, exclusive knowledge of the geographic location of the ISI as well as exclusive communication with the ISI-supplier is preserved for the ISI-demanding customer until the final transaction occurs, at which point the ISI is removed from the ISI system and the General Public can no longer see it as available or offered. It is up to the ISI-demander and ISI-supplier to talk and figure out how the ISI will be exchanged. The exchange of ISI between customers may occur in various ways, such as via direct transport between the customers (i.e. physical meeting of the customers, via the postal service, a private delivery company, an unattended physical pickup, etc.), or instead as the ISI system or another entity acting as an intermediary (not shown). While the previous ISI transaction example was initiated when an ISI-supplying customer requested an ISI from the ISI system, such an ISI transaction may similarly be initiated when an ISI-providing customer indicates to the ISI system that the customer has an available copy of an ISI, and the ISI system indicates the opportunity to inform a specific type of ISI-demanding user, the Pre-Dibs Looker; the Pre-Dibs Looker exists when an ISI or attribute about ISI they recorded in their watchlist suddenly exists on the ISI system (in the form of ISI or attribute about ISI) as a result of an ISI-supplying user listing the ISI. Thus, before the General Public the Pre-Dibs Looker has a preset time opportunity to know of the existence of the ISI and also activate Dibs on the ISI.

The illustrated ISI system may also perform various other actions, such as tracking and using various information about the customers and their activities. For example, the ISI system may track current “points” or other credits provided by the ISI system, such as points that are credited by the ISI system to customers who sell (or supply) ISI and that are debited by the ISI system from customers who buy (or demand) ISI. In addition, while illustrated here as separate groups for the sake of clarity, it will be appreciated that at least some of the customers of the ISI system may be both ISI-supplying customers and ISI-demanding customers, such as for different ISI and by interacting with other customers. Furthermore, the ISI-demanding users 110 and ISI-supplying users 120 may interact with the ISI system and optionally each other in various ways (not shown), such as via website provided by the ISI system and/or by using other electronic communications methods (i.e. SMS, MMS, instant messaging, text messaging, telephone, email, etc.).

In this example, the ISI system 100 is operated by a merchant (not shown), and is electronically interacting with another affiliated system that may also optionally be operated by the merchant or instead by a third-party operator. In this example, the other affiliated system could be an external payment processing service 150 that processes indicated payments on request, such as from and/or to customers. In other embodiments, the ISI system may instead include its own payment processing capabilities. In addition, in at least some embodiments, the ISI system may instead include its own payment processing capabilities. In addition, in at least some embodiments, the ISI system operation may be enhanced in various ways via interactions with one or more other types of affiliated systems, such as external ISI marketplaces 140 operated by the merchant and/or by third-party operators. Interactions with such external marketplaces may include, for example, automatically obtaining and using information related to users of the ISI system from those marketplaces (i.e. if the ISI system users are also users of the external marketplace), and/or by acquiring additional items or item information from those marketplaces may include new item marketplaces that sell new items of one or more types to customers (i.e. via an e-commerce store, physical brick-and-mortar retail stores, physical or electronic auction sites, etc.) and/or used item marketplaces that sell used items of one or more types to customers.

In some embodiments, the ISI system may charge a transaction fee to customers under certain circumstances, such as to each customer who receives an item or service or information about the item or service through the ISI system (i.e. in addition to points or other credits that are debited from the customer receiving the item). If so, the ISI system may or may not interact 151 with the payment processing service 150 in this example (depending on subscription or status of user's membership) to accompany the Looker's 110 activation of the Dibs button. At such time the Looker might pay before, at the same time, or after they activate the Dibs button (and become a Dibber) in order to secure priority access to ISI and exclusive access to the ISI's geographic information (location on map, coordinates, street address, etc.) and exclusive messaging with the ISI's Lister 120. Depending on the user's preferences, the ISI system may interact with the payment processing service 150 in this example to obtain the appropriate transaction fees from the customers, including obtaining pre-paid transactions fees in certain circumstances. For example, the customers may have previously interacted with the ISI system (i.e. during a customer registration process) to specify one or more fee payment mechanisms that the payment processing service is directed to use, such as a credit card, bank account, or other source of funds.

The Physical Dibs button is similar to the Dibs button users find on a website, except it is physically—rather than digitally—presented to the user. A user who is shopping in a physical store, public park or out in the open, transit station, moving or parked vehicle, private residence, outer space, or other physical location in the world or universe may encounter the Physical Dibs button. Registered and logged into an account affiliated with the ISI Transaction System, the user can activate the Physical Dibs button to get priority access to ISI; specifically, activating the Physical Dibs button may give the ISI-Demanding User 110 the opportunity to message or signal to the ISI-supplying user 120 that they are interested in their offering. Once activated the Physical Dibs Dibber has a preset time opportunity to engage in communication with the ISI-supplier in order to secure their full privilege of priority access to ISI. The Physical Dibs button may be connected to a system that prints a ticket or receipt, emails a message or communicates a message in another manner. The Physical Dibs button may be connected to a system that signals or brings the next step of a process, such as giving out a code; the secret code or code might be a password, keyword, number, or something that enables the Dibber to have access to special offers or coupons or allow them to do the next step of a process before others who don't have the code. The Physical Dibs button interaction may also include the physical exchange of ISI with identification on the part of the ISI-demanding user. Like the Dibs button, the Physical Dibs button awards the Physical Dibs Dibber priority access to the geographic and written location of ISI as well as exclusive communication with the Lister or entity. Lastly, the behavior of the Pre-Dibs Physical Looker functions like the Pre-Dibs Looker except that in such an example embodiment, the Pre-Dibs Physical Looker activates a Physical Dibs button. It's worth noting that Physical Dibs Dibbers or Normal Dibs Dibbers receive priority access to the ISI (location, etc.) and it's up to them what they do with the location information. They can keep that information for themselves or even choose to share the location or information about the Dibbed ISI with other people. One embodied scenario concerning a scavenger hunt would be a licensed company or licensed individual hides a Physical Dibs button somewhere in a city, park, or elsewhere and people see the Physical Dibs button and activate Dibs to get priority access or specials deals or win ISI, and the Dibbers may then share the locations of the Physical Dibs buttons or ISI with other specific participating Lookers, as these deals are in high demand. They can choose individuals or groups of individuals with whom to share or not share their Dibbed ISI after they activated the Physical Dibs button or Normal Dibs button.

For illustrative purposes, some embodiments are described below in which specific types of ISI and users are involved in transactions in specific ways, and in which an ISI Transaction System facilitates such ISI transactions in various ways (i.e. in which ISI transactions occurring via the ISI system involve the ISI system's use of a Dibs button or Physical Dibs button, or situations when there's a Pre-Dibs Looker instead of a Normal Looker). Within the ISI's operating environment exists a macro flow and micro flow, whereby the micro flow's possible users are not limited to being an Anonymous Lister, Anonymous Looker, Lister, Looker, Pre-Dibs Looker, Dibber, Physical Dibs Dibber, Pre-Dibs Physical Looker, and Admin. More details about these elements are described in the embodiments below. However, it will be appreciated that the described techniques may be used in a wide variety of other situations, including with other types of ISI, and that the invention is not limited to the exemplary details provided.

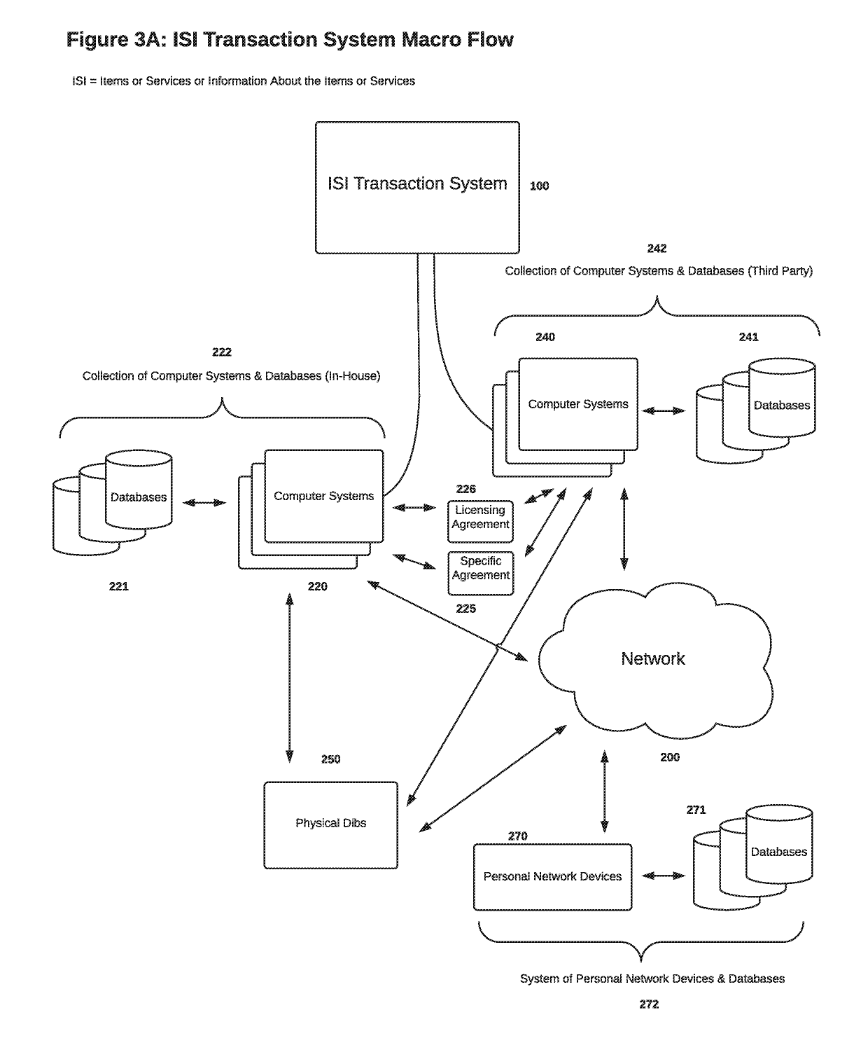

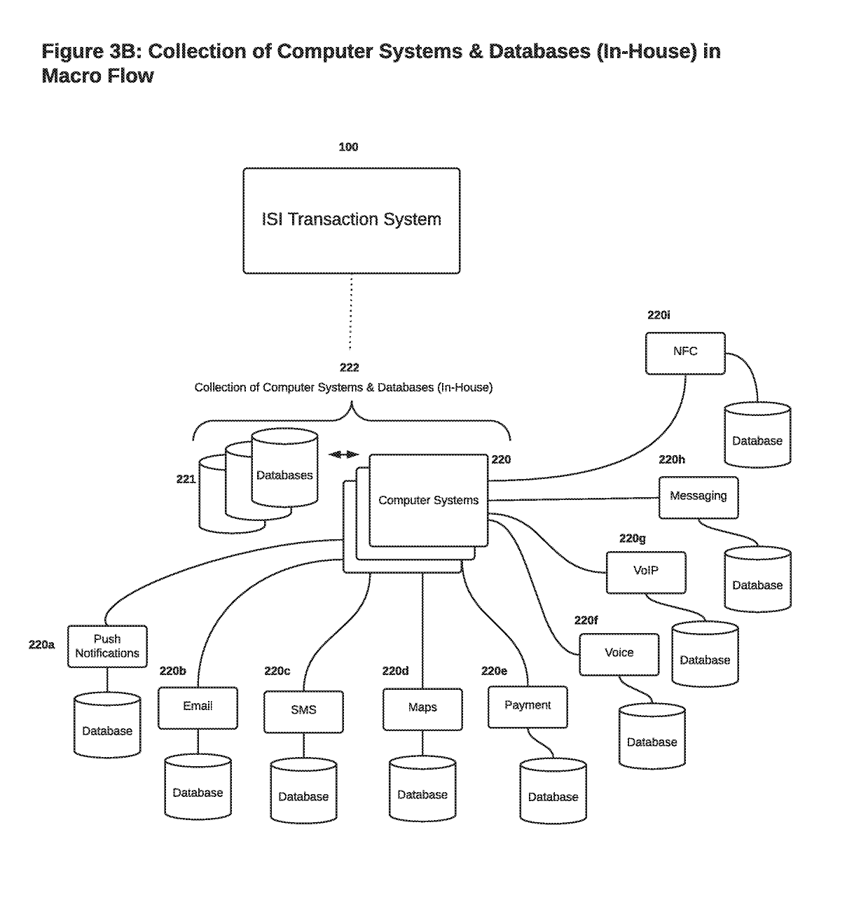

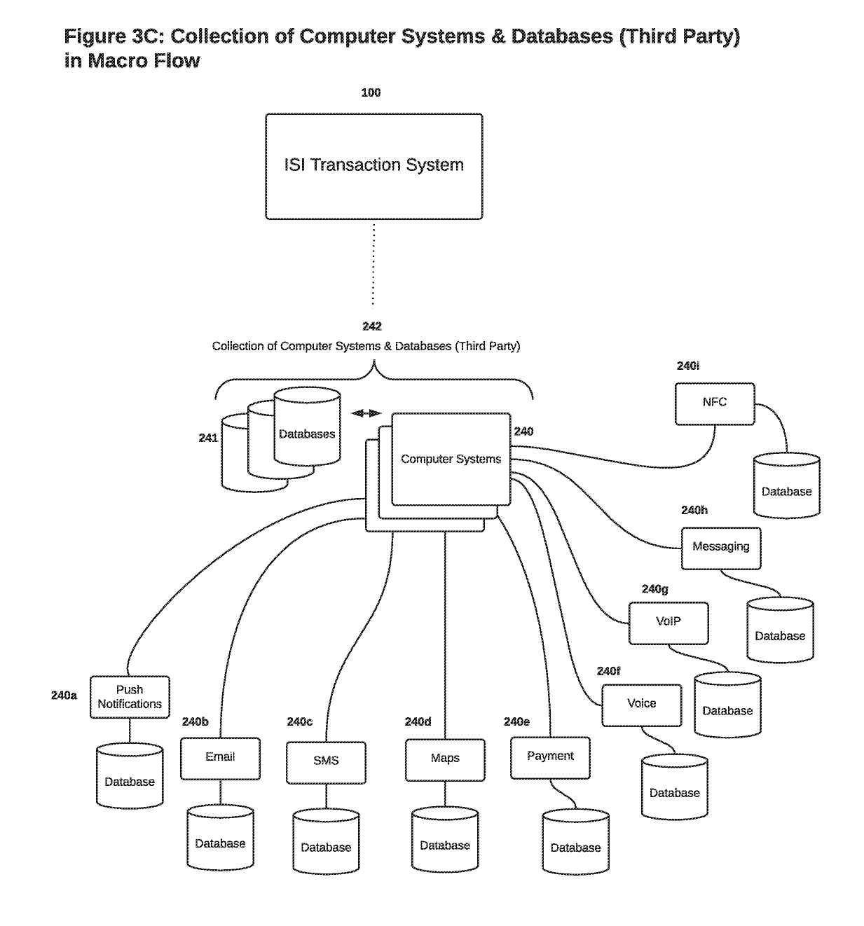

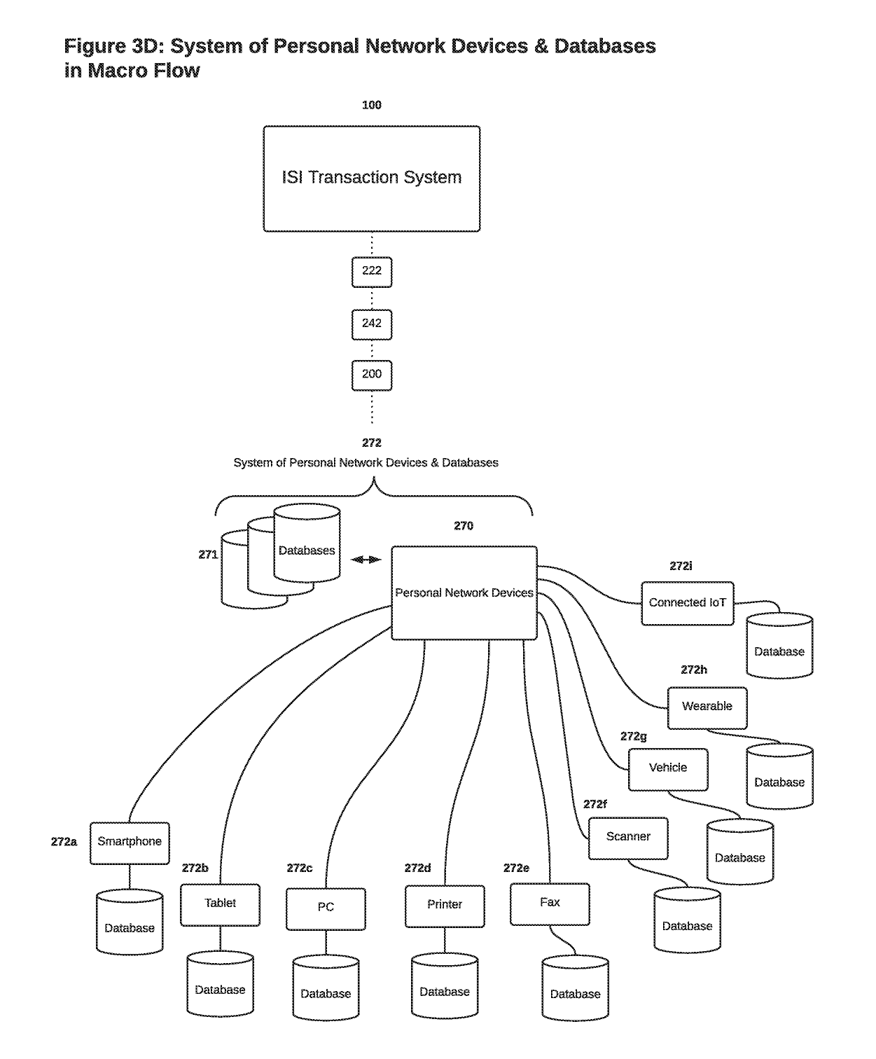

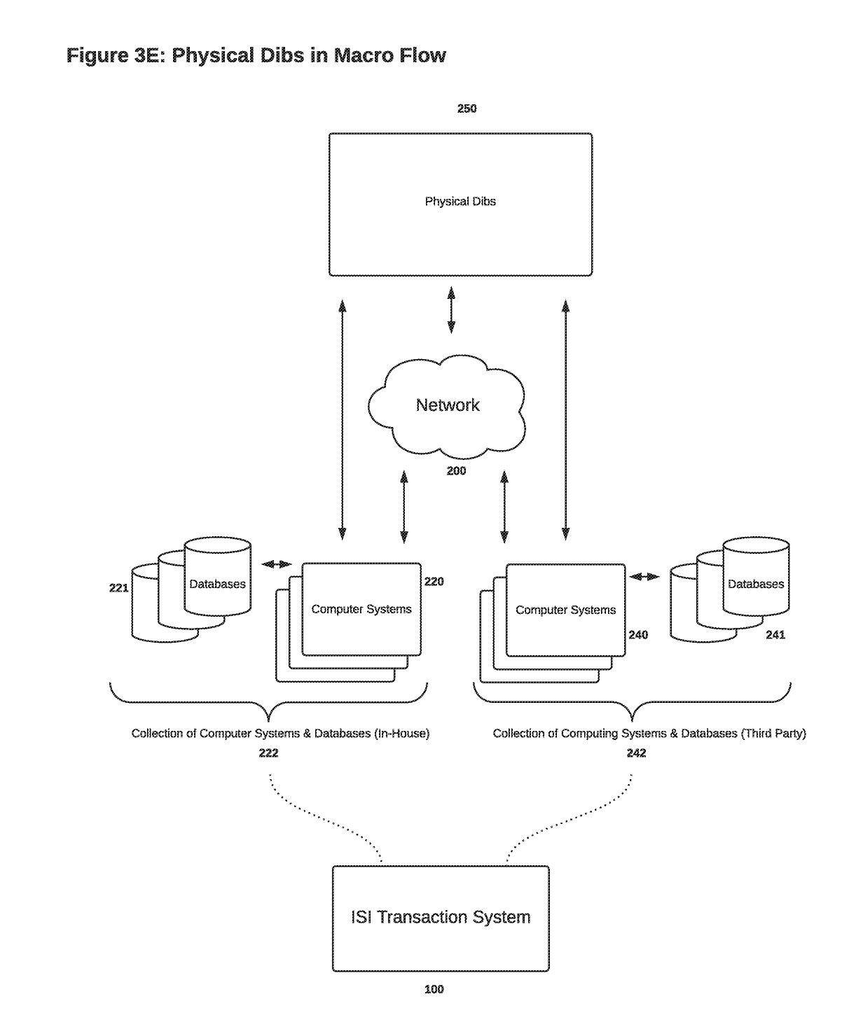

FIG. 3A illustrates an embodiment of an overview of the ISI Transaction System macro flow and FIGS. 3B-3E provide a closer look at the scope of the depictions within FIG. 3A. The ISI Transaction System 100 executes its processes though connection to an In-House Collection of Computer Systems 220 & Databases 221. Or, if there is a licensing agreement or some type of agreement in place with a Third Party, the ISI Transaction System may connect into a Third Party Collection of Computer Systems 240 & Databases 241. The ISI system may also connect with both the In-House 222 and Third Party 242 Collection of Computer Systems and Databases at the same time for the Dibs or Physical Dibs Processes. Moreover, the In-House Collection or Computer Systems and Databases 222 may be directly connected to the Third Party Collection of Computer Systems and Databases 242 so the In-House and Third party entities' systems can communicate.

The ISI System executes on the In-House and/or Third Party Computer systems, which are connected to a Network 200 (i.e. the Internet) or the cloud, which is a network of remote servers hosted on the Internet and used to store, manage, and process data in place of local servers or personal computers. There are several different types of computer networks. Computer networks 200 can be characterized by their size as well as their purpose. The size of a network can be expressed by the geographic area they occupy and the number of computers that are part of the network. Networks can cover anything from a handful of devices within a single room to millions of devices spread across the entire globe. Some types of networks based on size are LAN (local area network), WAN (wide area network), WLAN (wireless local area network), MAN (metropolitan area network), and PAN (personal area network). In terms of purpose, many networks can be considered general purpose, which means they are used for everything from sending files to a printer to accessing the Internet. Some types of networks, however, serve a very particular purpose. Some of the different networks based on their main purpose are SAN (storage area network), EPN (enterprise private network), and VPN (virtual private network). The Network 200 is the interchange where ISI data flows between the In-House 222 and/or Third Party 242 Collection of Computer Systems & Databases and a System 272 of Personal Network Devices 270 & Databases 271 such as smart phones, tablets, personal computers, printers, fax machines, scanners, vehicles, wearables, connected Internet of Things (or “IoT”), and other machines or appliances. The electronic signal(s) or means by which data migrates between the System of Personal Network Devices 272, the Network 200, and the In-House 222 and Third Party 242 Collection of Computer Systems & Databases may be wired such as through cord or cable connection (coaxial), fiber optic, broadband over power line, DSL, dial-up or similar. Additionally, the electronic signal(s) or means by which data migrates between the System of Personal Network Devices 272, the Network 200, and the In-House 222 and Third Party 242 Collection of Computer Systems & Databases may be wireless such as through NFC (Near Field Communication) like wireless broadband, mobile internet, satellite internet, or similar, or Bluetooth, a popular technology designed specifically for the purpose of making Near Field Communication possible, sold under the trademark “Bluetooth SIG, Inc.”. Lastly, the Physical Dibs 250 is connected to the Network 200, or directly to the In-House Collection of Computer Systems 222 and/or directly to the Third Party Collection of Computer Systems 242. The Physical Dibs may employ the same or similar wired or wireless means of data migration just mentioned.

FIG. 3B and FIG. 3C provide a closer look at the In-House 222 Collection of Computer Systems 220 & Databases 221 and the Third Party 242 Collection of Computer Systems 240 & Databases 241, respectively, that are depicted in FIG. 3A. The ISI Transaction System may execute on one of or both of these systems. One difference between the In-House systems 222 and Third Party 242 systems is that a Specific Agreement 225 may allow the Third Party 242 systems client or entity permission to use along with the In-House systems 222 or by itself without the In-House systems 222. Furthermore, in this example embodiment, a Licensing Agreement 226 may allow a Third Party 242 client the authority to use the ISI Transaction System on their own Third Party Collection of Computer Systems & Databases 242 without having to connect directly or indirectly with the leasing or licensing client's In-House Collection of Computer Systems & Databases 222. The In-House Databases 221 and Third Party Databases 241 are an organized collection of data. The data is typically organized to model aspects of reality in a way that supports processes requiring information, such as modeling the availability of ISI in a way that supports finding the ISI easily on a map. The In-House Computer Systems 220 and Third Party Computer Systems 240 communicate with their respective databases, and may or may not have certain read and write privileges, or file access privileges. The software developers working to improve or upkeep the different In-House 222 and Third Party 242 Collections of Computer Systems & Databases may employ a practice known as Continuous Integration (or “CI”), which is a development practice that requires developers to integrate code into a shared repository several times a day; each check-in is then verified by an automated build, allowing teams to detect problems early. It would be established in a prior Specific Agreement 225 or Licensing Agreement 226 how or if any form of software development or maintenance on the Collection of Third Party Computer Systems and Databases 242 would be possible. These protocols would apply to any potential execution of ISI, including the Dibs button and Physical Dibs button.

It has been noted in FIG. 3A that the ISI Transaction System 100 executes on a Collection of In-House 222 and Third Party 242 Computer Systems and Databases and connects through a Network 200 to a System of Personal Network Devices & Databases 272 and/or the Physical Dibs button 250. In FIGS. 3B-3C we see various application programmable interfaces (or “APIs”). More specifically, an API is a set of routines, protocols, and tools for building software applications. The API specifies how software components should interact and APIs are used when programming graphical user interface (GUI) components. Examples of APIs that may live in the In-House 222 and Third Party 242 Collection of Computer Systems and Databases—and help to pass ISI through the Network 200, System of Personal Network Devices & Databases 272 and/or the Physical Dibs button 250—are Push Notifications 220a and Push Notifications 240a, Email 220b and Email 240b, SMS (Short Message Service) 220c and SMS 240c, Maps 220d and Maps 240d, Payment 220e and Payment 240e, Voice (calling on phone or other device) 220f and Voice 240f, VoIP (Voice over Internet Protocol) 220g and VoIP 240g, Messaging (instant messaging, MMS or “Multimedia Messaging Service”, IRC or “Internet Relay Chat”, video chat) 220h and Messaging 240h, Near Field Communication (NFC) 220i and (NFC) 240i such as Bluetooth, as well as other types of APIs. Depending on the API protocol, the technical architecture can be peer-to-peer (direct point-to-point transmission) or client-server (a central server retransmits messages or data from the sender to the communication device). In the example, complementing each of the APIs 220a-220i and APIs 240a-240i is their own In-House or Third Party database.

The API examples in FIGS. 3B-3C may occur in various instances, and users may configure in their preferences how some of the APIs work for them. For example, an API that handles Push Notifications 220a and Push Notifications 240a may be used to alert a Lister that their ISI has been Dibbed (if a Looker has activated the Dibs button or Physical Dibs button on their ISI) or sent them an in-app message or contacted them in some way. The Lister may also be alerted if a Looker publicly commented on their ISI and if or when their ISI has been picked up. A Pre-Dibs Looker might receive a Push Notification (on their smartphone, tablet, wearable, vehicle, or other device, appliance, or machine via a Push Notification API through the Platform's mobile app, website, or other communication methods common in the art) if an ISI on their watchlist becomes available, which was triggered by the Pre-Dibs Looker adding an attribute or tag or category related to that ISI to their watchlist. On some devices, when a device receives a Push Notification, the application's icon and a message appear in the status bar. The Dibber might receive a Push Notification to confirm that they just Dibbed an ISI or to alert them when a Lister responds to their in-app message. The Dibber might also receive a Push Notification to confirm if they have picked up the ISI (or exchanged the ISI). Generally Push Notifications 220a and Push Notifications 240a are helpful to alert users when something happens and their action might be needed. Email 220b and Email 240b may be used to confirm to Lister and/or Looker that the ISI has been posted on the map and successfully stored on the Databases 221 and Databases 241. Email also may be used to notify the Lister that someone has a question about their posted ISI, that someone has Dibbed their ISI, or to ask them to confirm if their ISI has been picked up. For the Looker, email may be used to confirm that their ISI has been Dibbed, that they have a response to a comment, notification of any watched tags or attributes (via watchlist), and to confirm if they have picked up the ISI they committed to getting since they activated the Dibs button. Generally Email 220b and Email 240b is used to alert users when something happens and their action might be needed.

APIs that may be useful like SMS 220c and SMS 240c, Voice 220f and Voice 240f, VoIP 220g and VoIP 240g, and other In-House Messaging 220h or Third Party Messaging 240h methods such as in-app messaging are useful for the Lister and the Dibber to communicate privately and anonymously when they attempt to coordinate the pickup or exchange of ISI. Generally, various people (i.e. Dibber and Lister) or other entities use these communication techniques to make contact so they can ask questions and converse, set or negotiate the pickup time or place or other details, exchange the ISI by physically meeting or not, and ultimately so the ISI may be removed from the Platform and made invisible to the General Public by the Collection of In-House 222 and Third Party 242 Computer Systems and Databases. The Dibber or Lister may notify the ISI Transaction System once the ISI has been picked up, which tells the system to remove the ISI from the Platform. The transaction data, purchasing data, personal data, or other information data about each ISI, the users involved with the transaction of the ISI, and the nature of the post-sale tracking of ISI is retained by the Admin group or In-House Databases 221. A collection of this data may be used for future purposes of research, marketing and advertising, product development, and other business and product purposes that general and specific data is used for that are common in the art.

APIs designed specifically for the purpose of making web maps include ESRI's software, ArcGIS API for JavaScript, sold under the trademark “ESRI” and Google's software, Google Maps API, sold under the trademark “Google Maps” mapping service. The ISI Transaction System uses a Maps 220d API and Maps 240d API to visually display ISI geographically on a map. After a Lister lists (or posts) ISI onto the system, their ISI appears on a map, viewable to Lookers. For example, if a Lister was to give away or sell a bicycle, they may capture an image of the bicycle with a smartphone or other device and commit their image of their ISI onto the ISI Transaction System's map so their offer of ISI is viewable to Lookers, or people or entities that may be interested in the bicycle. When a Looker decides they want the ISI, or bicycle, they can activate the Dibs button and have the ISI removed and/or have this ISI's Dibs button removed from the Map 220d and Map 240d (and display or user interface) so other Lookers don't know any information that tells them where the item is located; at the same time the Dibber may send an in-app message to the Lister about the bicycle via a Messaging API 220h and Messaging API 240h so they can ensure that they secure their full privilege to Dibs the ISI, or bicycle in this case. If the Dibber fails to message the Lister or for some reason is rejected by the Lister or forfeits their ability to secure their Dibs priority access to the ISI (to be the only one to know where the item is and have exclusive communication with the Lister), then the ISI may reappear on the Map 220d and Map 240d, once again viewable to the General Public as the ISI is moved from Inactive Inventory to Active Inventory.

APIs designed specifically for the purpose of processing payment include PayPal's software, “Braintree” and “Venmo”, sold under the trademark “PayPal, Inc.”, and WePay's software “WePay”, sold under the trademark “WePay, Inc.”. Depending on the type of subscription or membership status, a Payment API 220e and Payment API 240e such as Braintree, Venmo, or WePay, may be used to process payments. In some cases, the payments may be transactional. For example, a Dibber may have to pay currency or credits the moment they activate the Dibs button or Physical Dibs button. The Third Party Payment APIs will assist the ISI Transaction System to quickly process the payments for specific instances. For example, if a Looker wants ISI such as a TV they may activate the Dibs button for the TV and be prompted to pay five dollars for the ISI relating to the TV before they officially become a Dibber and are connected with the Lister of the TV (owner of TV's listing). Once the Looker pays the transaction cost for the ISI they become the Dibber and may proceed with their responsibility to message or contact the Lister in order to secure the rest of their Dibs privileges to achieve having Full Dibs Functionality. In other instances, if they qualify to do so based on membership status, the user may be able to configure in their preferences that they'd like to be charged for their ability to use the Dibs or Physical Dibs button on a monthly, weekly, or periodical basis.

The Physical Dibs may use NFC 220i and NFC 240i, which is a set of ideas and technology that enables smartphones and other devices to establish radio communication with each other by touching the devices together or bringing them into proximity to a distance of typically 10 cm (3.9 in) or less. For example, a Looker might register and log into their account on Platform associated with the ISI Transaction System and then activate the Physical Dibs button (by making physical contact with their hand or hovering their device or devices over button). After doing so, the NFC 220i API and NFC 240i API triggers the printing of a ticket or receipt, allows for physical exchange with further identification, and/or sends a message to the Dibber with information or further instructions.

FIG. 3D provides a closer look at System of Personal Network Devices 270 & Databases 271 that are depicted in FIG. 3A. The ISI Transaction System 100 executes on a Collection of In-House 222 and/or Third Party 242 Computer Systems and Databases and connects through a Network 200 to a System of Personal Network Devices & Databases 272. Examples of Personal Network Devices 270 are Smartphone 272a, Tablet 272b, PC (Personal Computer) 272c, Printer 272d, Fax 272e, Scanner 272f, Vehicle 272g, Wearable 272h, Connected IoT 272i (Internet of Things, which is a network of physical objects or “things” embedded with electronics, software, sensors and connectivity to enable it to achieve greater value and service by exchanging data with the manufacturer, operator and/or other connected devices), as well as other devices, appliances, or machines. In the example embodiment, complementing each of the Personal Network Devices 272a-272i is their own In-House or Third Party database. Some types of human or nonhuman users that may use their Personal Network Devices 270 to access the ISI Transaction System 100 are the Anonymous Lister, Anonymous Looker, Lister, Looker, Dibber, Pre-Dibs Physical Dibber, Physical Dibs Dibber, and Admin.

FIG. 3E provides a closer look at Physical Dibs 250 that is depicted in FIG. 3A. The ISI Transaction System 100 executes on a Collection of In-House 222 and/or Third Party 242 Computer Systems and Databases and connects through a Network 200 and/or directly to the Physical Dibs 250 button. Depending on the type of connection (such as a wired bond) or agreement the Physical Dibs may (or may not) be physically or virtually independent or unassociated of the Network 200.

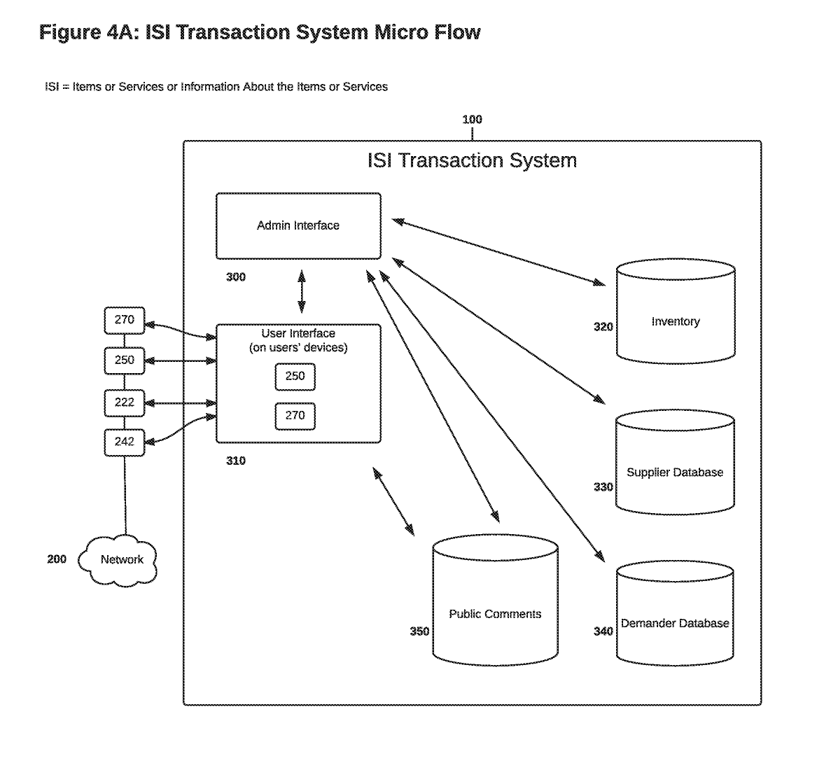

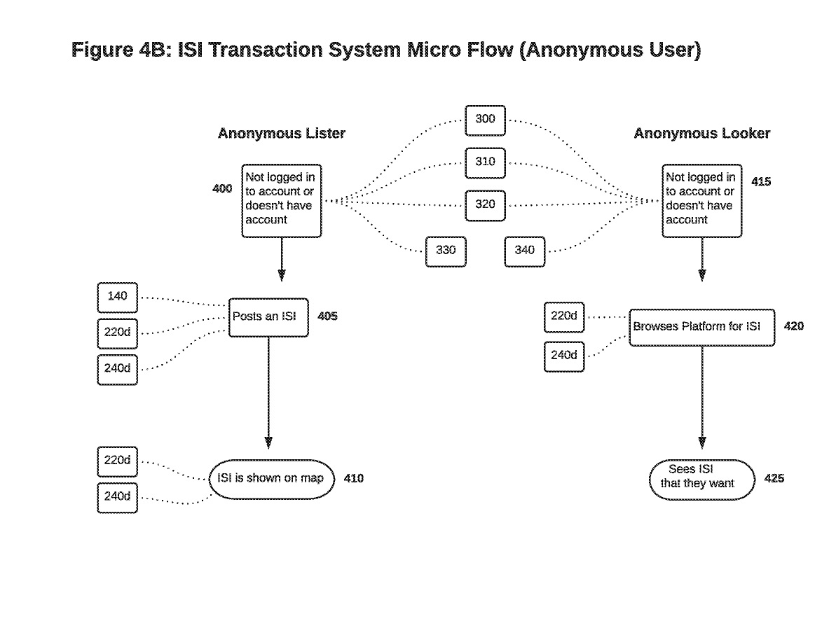

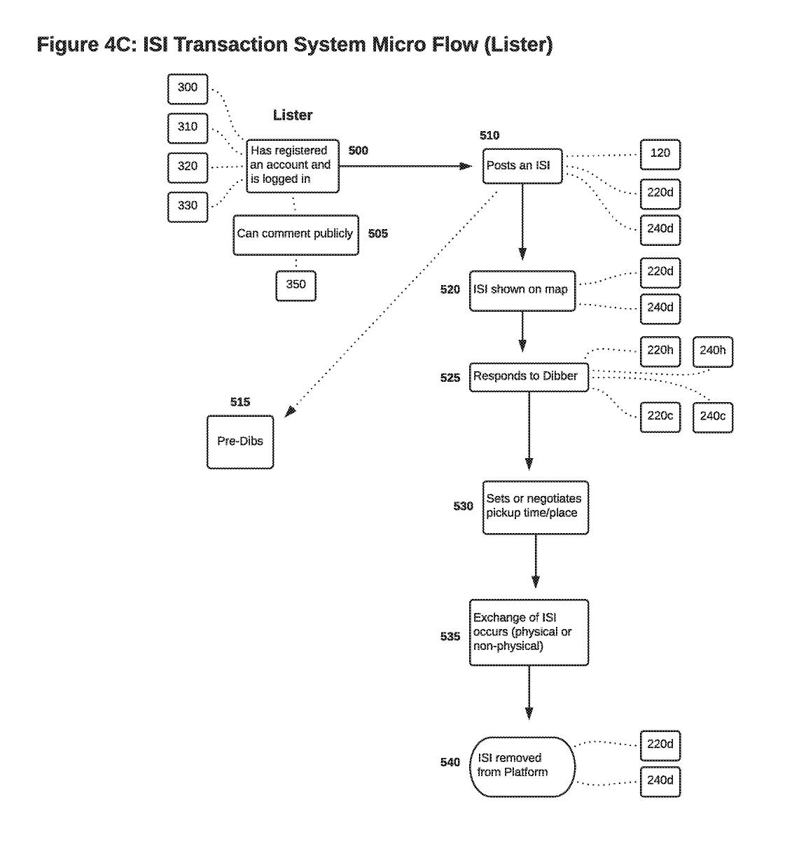

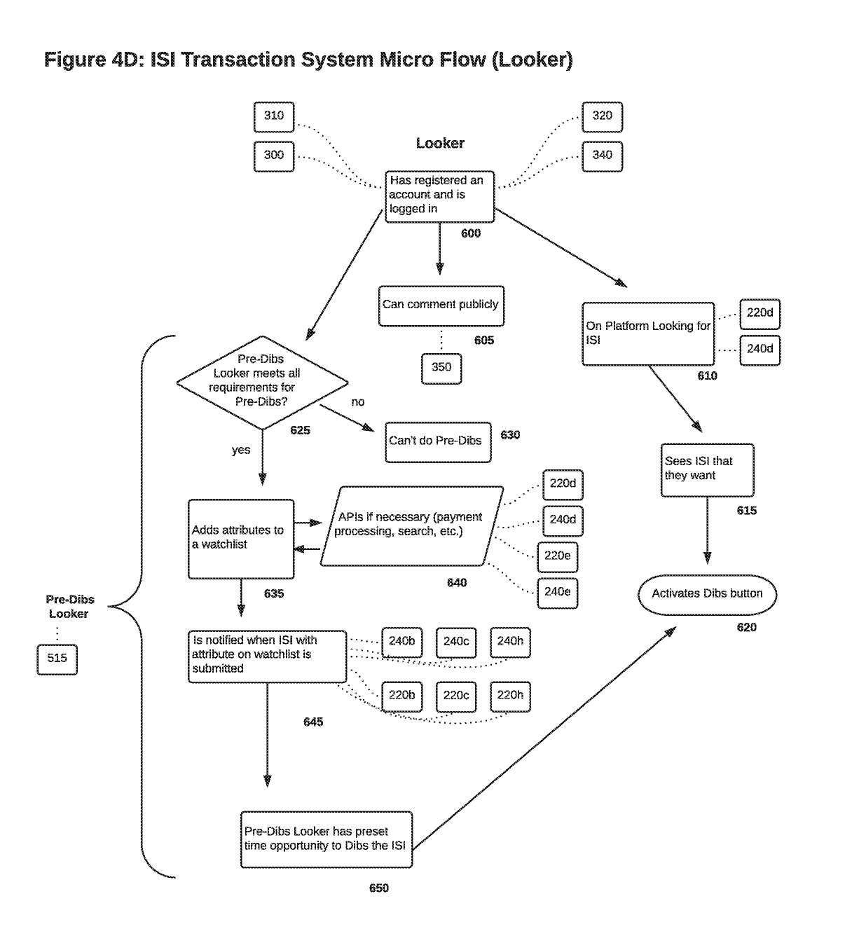

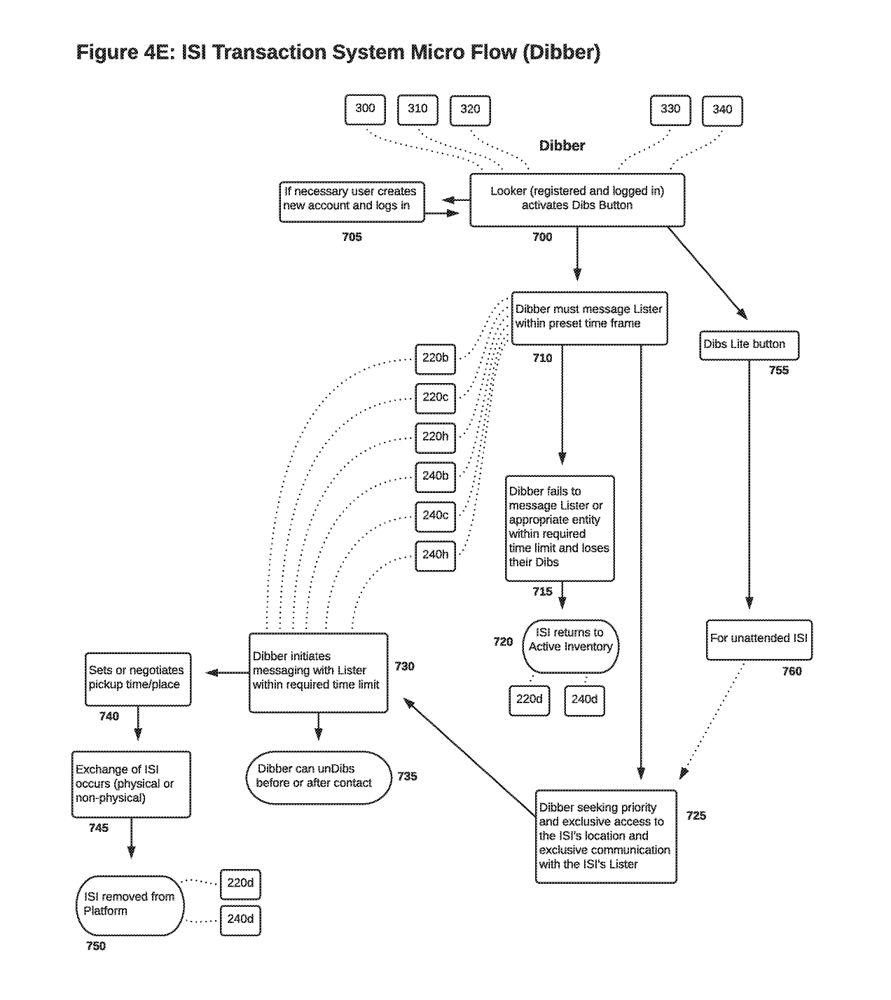

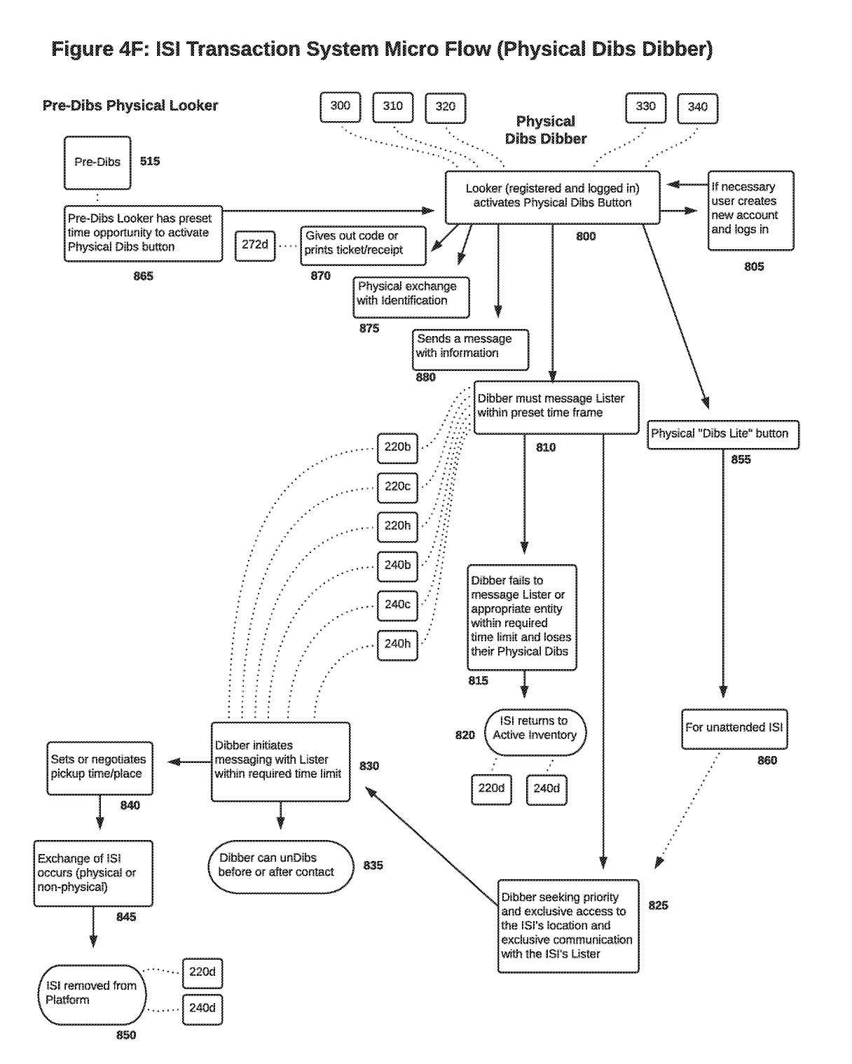

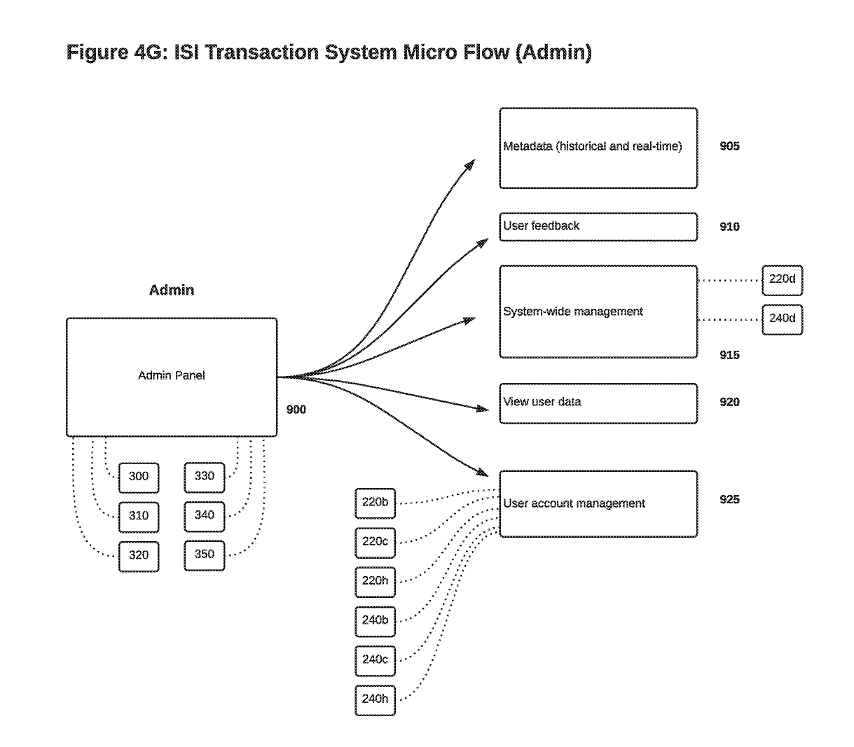

FIG. 4A illustrates an embodiment of an overview of the ISI Transaction System micro flow and FIGS. 4B-4G provide a closer look at the scope of the depictions within FIG. 4A. The ISI Transaction System's 100 command center is the Admin Interface 300, which can access the User Interface (on users' devices 272a-272i), Inventory (general storage databases) 320, Supplier Database 330, Demander Database 340, and Public Comments 350. Operating outside of the ISI Transaction System 100 are the In-House Collection of Computer Systems & Databases 222 and the Third Party Collection of Computer Systems & Databases 242. The Personal Network Devices & Databases 270 and Physical Dibs 250 may operate outside the ISI Transaction System 100 and inside the ISI Transaction System 100 within the User Interface 310. The Admin Interface 300 must allow permission to the elements within the User Interface 310 to access Inventory 320, Supplier Database 330, Demander Database 340, and Public Comments 350. For example, when a Looker activates Dibs on an ISI and becomes a Dibber, the person or entity must go through the ISI Transaction System's 100 process to officially earn their complete Dibs privilege—also known as Full Dibs Functionality—by performing the appropriate actions that are required by the Admin Interface. The User Interface 310 may access the Public Comments 350 database directly, as there is no need for the Admin Interface 300 to process and vet the Looker to post a public comment like it must for a Looker who activates the Dibs button with the intention to become an official Dibber.

Within the Demander Database 340, Demanders are any type or form of Pre-Dibs Looker, Looker, or Dibber. Information gathered and stored on these users may be keywords they use to search for ISI (so efforts can be made to build supply of certain types of ISI for these specific users), their location as indicated by the users or their devices, attributes and categories certain Lookers tend to search for, ISI they have Dibbed in the past, amount of money or credits they have spent, payment information, as well as personal information and other data that may be used for marketing, selling, product improvement, or informational purposes. The Platform will collect and store numerical data, geographic data, descriptive data, and any sort of qualitative or quantitative data based on the users' active or passive activity on the Platform. The data will be stored in columns and/or rows in a spreadsheet (such as in a software program spreadsheet), in the databases' servers, in the codebase, and in other methods common in the art. Within the Supplier Database 330, Suppliers are any type or form of Lister. Information gathered and stored on these users may be ISI they list (past and present), popular pickup times indicated by the Listers, number of activated Dibs on their ISI, number of ISI Dibbed for a particular user, attributes attached to listed ISI, categories selected for the listed ISI, type of device they use, location of where the ISI is listed, images and videos, amount of money or credits their ISI has made, payment information, as well as personal information and other data that may be used for marketing, selling, product improvement, or informational purposes. The Platform will collect and store numerical data, geographic data, descriptive data, and any sort of qualitative or quantitative data based on the users' active or passive activity on the Platform. The data will be stored in columns and/or rows in a spreadsheet (such as in a software program spreadsheet), in the databases' servers, in the codebase, and in other methods common in the art. Lastly, other general data collected on users such as Listers and/or Lookers are conversations of ISI (subject, when created, when last updated, conversable details), notifications about ISI (ID, type, body, subject, conversation #, draft status), messages (ID, type, body, subject, sender, conversation, receipts), receipts (ID, Receiver, Notification, ready status, trashed status, deleted status), Dibs (ID, IP address, valid until when, status, user, post), list of posts (ID, title, description, image url, video url, address, latitude, longitude, status, IP address, time Dibbed until, image, published, conversation), general reports (ID, Dib, Description, Rating, when created, when last updated), Pre-Dibs watchlist attributes (ID, IP address, attribute/keyword, time entered, valid until, status, user), and user data (email, password digest, status, IP address, first name, last name, username, verified email, Dibs, messages, reports, receipts).

The ISI Transaction System 100 executes on a Collection of In-House 222 and/or Third Party 242 Computer Systems and Databases, which include a CPU, various input/output (I/O) components, storage, and memory (not all shown). The I/O components include a display, a network connection, a computer readable media drive, and optionally other I/O devices (i.e. a keyboard, mouse, etc.), which are also present on the System of Personal Network Devices 270 and Physical Dibs 250. FIG. 4A also illustrates multiple user client computing systems labeled as Personal Network Devices 250 that users may use to interact with the ISI Transaction System 100 via a Network 200 (i.e. the Internet). The ISI Transaction System may also interact over the Network 200 with one or more In-House 222 or Third Party 242 computing systems, such as to interact with other affiliated systems (i.e. one or more external ISI marketplaces or other external sources of information) 242. The Admin Interface 300 and User Interface 310 in the ISI Transaction System 100 and the outside Personal Network Devices & Databases 270, Physical Dibs 250, In-House Collection of Computer Systems & Databases 222 and the Third Party Collection of Computer Systems & Databases 242 are executing in a memory environment, which may optionally include one or more other systems, such an executing payment processing service, or may instead interact with other such systems remotely over the network. During operation, the ISI Transaction System 100 may store and use various information on one or more databases (or other types of information stores). In this example embodiment, storage includes Inventory 320, Supplier Database 330, Demander Database 340, and Public Comments 350. Within the Platform's website, mobile app, or other, there exists a Public Comments conversation thread. A single Lister can correspond publicly with multiple Lookers in a public online forum. Public Comments may be used by a Looker (who is registered and logged in to the Platform) who wants to ask a question to the Lister (also registered and logged in to the Platform) about their listed ISI without having to activate the Dibs button; Public Comments may be available for ISI that hasn't been Dibbed as well as ISI that is currently Dibbed. Although ISI may be Dibbed, it's possible for the ISI's image or video, description, or attributes to be available and visible to the Looker even while the Dibbed ISI's Dibs button, location, written address, and coordinates may have been hidden or removed. This allows for other Lookers to still know about the existence of the ISI and engage in a public conversation with the Lister, ask questions, and be available to claim the ISI if the current Dibber cancels (unDibs) their activated Dibs or fails to achieve Full Dibs Functionality status. The Dibber may even flake out on their commitment by failing to communicate with the Lister or by not showing up to exchange the ISI. And the Lister may reject the Dibber's Dibs and know that another Looker has indicated in the Public Comments section (attached to their individual listed unit of ISI) that they might demand their ISI and may want to activate the Dibs on their ISI, if they were able to. The Public Comments 350 section also allows for Listers to respond to questions asked by Lookers only once. Once they respond to a question, it's available for other Lookers to see the answer to their question. Thus, the Public Comments section minimizes the input requirement for the Lister in terms of responding to the same or similar questions or messages sent from many Lookers. It's also possible to have a Third-Party plug-in API such as Facebook that allows the Platform to use a similar design layout and user experience for Public Comments, as would the In-House Public Comments solution provide. Private parties, such as the Dibber and, as already mentioned, the Lister, can also correspond in Public comments, even though they have other exclusive means of communication such as through in-app messaging, or other.

Within the ISI system the Admin Interface 300 oversees anything relating to a method for prioritizing and transacting the sale or transfer of geographically positioned items and services. The type of user who may access the Admin Interface 300 is an Admin. The Anonymous Lister, Anonymous Looker, Lister, Looker, Dibber, Pre-Dibs Physical Dibber, Physical Dibs Dibber, and Admin may access the User Interface 310. The Admin has all access to all systems within the ISI Transaction System 100. FIGS. 4B-4G depict user flow diagrams that go into more detail about how the embodiments 300-350 apply to each type of user.

The Admin Interface 300 and User Interface 310 working with the databases 320-340 facilitates ISI transactions between users by selecting appropriate users to receive opportunities to provide ISI available from those users, such as in a manner to balance supply and demand for ISI (Pre-Dibs or Normal Dibs for example), and by notifying the selected users of those opportunities. In an embodiment, a determination to select users may be initiated in various ways, such as changes in supply and/or demand (based on user interactions within the User Interface 310 component). In addition, the selection of which users to notify of an ISI supply opportunity may be made in various ways. In performing its operation the Admin Interface 300 and User Interface 310 may use various information about customers and ISI from the databases 320-340. This also allows for the generation of various information related to its user selection determination and may store that information in the databases 320-340, such as information about over-supply and under-supply of particular ISI that are available from particular users, and about the effect of providing ISI supply opportunities to various users on the over-supply and under-supply of ISI. As previously noted, the notifications performed within the Admin Interface 300 may have various forms, such as based on various types of electronic messages (not shown) that are sent to the users being notified.

The User Interface 310 component interacts with users to provide various functionality, including to provide information to users about ISI, such as in response to user requests. In providing the information, the component accesses various information about the ISI via the Admin Interface 300 from the databases 330-340, and may also access various information from the demanded ISI and available ISI Inventory databases 320.

The Admin Interface 300 component provides functionality to allow ISI transactions involving customers to occur. In particular, the component identifies customers who demand ISI and identifies other customers who have those ISI available, so that the User Interface 310 component may engage in ISI transactions to purchase or transfer ISI from customers who have ISI available and to sell ISI to customers who demand ISI. The ISI transactions of the User Interface component may be initiated in various ways, such as in response to requests from customers who are willing to provide ISI, in response to requests from customers who demand to receive ISI, and/or by analyzing demand ISI lists and available ISI lists to identify matches. Working with the Admin Interface 300 the User Interface 310 component may also take various additional actions to facilitate the ISI transactions, such as by obtaining any corresponding fees and other payments [i.e. based on interactions with the payment processing service (not shown)], managing any points being credited or debited, providing instructions and/or shipping materials to enable the ISI transactions to occur, and tracking the progress of the ISI transactions. The Physical Dibs 250 may further in some embodiments facilitate ISI transactions by taking physical possession of ISI being provided by customers and then providing those ISI to the customers who demand to receive them, while in other embodiments may instead instruct customers providing ISI to directly provide those ISI to the customers receiving ISI. In performing its operations, the Physical Dibs 250 and its related database may access and use information from the available ISI information database, and may store information regarding ISI transactions in the storage Databases 320-350. The Inventory 320 database stores any and all information (such as external marketing ISI) that is not directly dealing with the ISI-Supplying Users and ISI-Demanding Users, which respectively associate their information with the Supplier Database 330 and Demander Database 340. The Public Comments 350 Database is inside the ISI Transaction System, where Lookers and Listers may publicly post questions about ISI.

It will be appreciated that collection of computer systems 222 and collection of computer systems 242 are merely illustrative and are not intended to limit the scope of the present invention. An embodiment of the ISI Transaction System may instead be executed by multiple interacting computing systems or devices, and collection of computer systems 222 may be connected to other devices that are not illustrated, including through one or more networks such as the Internet or via the World Wide Web (“Web”) or the cloud. More generally, a “client” or “server” computing system or device may comprise any combination of hardware or software that can interact, including (without limitation) desktop or other computers, network devices, PDAs, cellphones, wireless phones, pagers, smart watches, electronic organizers, Internet appliances, television based systems (i.e. using set-top boxes and/or personal/digital video recorders), and various other consumer products that include appropriate inter-communication capabilities. In addition, the functionality provided by the discussed system components may in some embodiments be combined in fewer components or distributed in additional components. Similarly, in some embodiments the functionality of some of the components may not be provided as part of the ISI Transaction System and/or other additional functionality may be available.

It will be appreciated that, while various items are discussed or illustrated as being stored in memory or on storage while being used, these items or portions of them may be moved between memory and other storage devices for purposes of memory management and data integrity. Alternatively, in other embodiments some or all of the software components may execute in memory on another device and communicate with the illustrated computing system via inter-computer communication. Some or all of the system components and/or data structures may also be stored (i.e. as software instructions or structured data) on a computer-readable medium, such as a hard disk, a memory, a network, a tangible transmission carrier, or a portable media article to be read by an appropriate drive or via an appropriate connection. The system components and data structures may also be transmitted via generated data signals (i.e. as part of a carrier wave or other analog or digital propagated signal) on a variety of computer-readable tangible transmission mediums, including wireless-based and wired/cable-based mediums, and can take a variety of forms (i.e. as part of a single or multiplexed analog signal, or as multiple discrete digital packets or frames). Such computer program products may also take other forms in other embodiments. Accordingly, the present invention may be practiced with other computer system configurations.

FIG. 4B is a flow diagram of an example embodiment for an Anonymous User (Anonymous Lister and Anonymous Looker). In this embodiment the Anonymous Lister user type's activity applies to the Admin Interface 300, User Interface 310, Inventory 320, and Supplier Database 330 while the Anonymous Looker user type's activity associates with the 300 Admin Interface, 310 User Interface, Inventory 320, and Demander Database 340 as embodied in FIG. 4A. The Anonymous User's intent is to be on the platform affiliated with the ISI Transaction System and do anything they are able to do without having registered an account or having logged in to their account. On the left side of FIG. 4B the Anonymous Lister visits the website or platform affiliated with the ISI Transaction System and does not have an account 400 or they are not logged into their account. Via an external marketing ISI channel 140 such as Twitter or Facebook the Anonymous Lister may provide an image or video of ISI, location of the ISI via an Application Programmable Interface (or “API”) that has to do with API Maps 220d and API Maps 240d, description of the ISI, and can categorize the ISI by assigning a tag(s), or specific attribute(s). They may even suggest a range of time or specific time that they will be available to later transfer their ISI. After the Anonymous Lister provides the information about the ISI they activate a button that posts their ISI 405 they want to provide and the ISI is shown on the map 410 (via Maps API 220d and Maps API 240d. On the right side of FIG. 4B the Anonymous Looker visits the website or platform affiliated with the ISI Transaction System and does not have an account or they are not logged into their account 415. The Anonymous Looker is looking for an ISI 420 (and they search for the ISI using an API for Maps 220d and Maps 240d and an API for search). The Looker sees the ISI that they want 425.

FIG. 4C is a flow diagram of an example embodiment for a Lister. In this embodiment the Lister user type's activity applies to the Admin Interface 300, User Interface 310, Inventory 320, Supplier Database 330, and Public Comments 350 as embodied in FIG. 4A. The Lister's intent is to List ISI they want to sell or give away to Lookers or users who may demand their ISI. First, the Lister has registered an account and is logged in 500. The Lister may wish to publicly reply to a question asked by a Lister 505. The Lister provides an image or video of ISI, location of the ISI via an API (that has to do with Maps 220d and Maps 240d, etc.), description of the ISI, and may categorize the ISI by assigning a tag(s), or specific attribute(s). The Lister may even suggest or select a range of time that they will be available to later transfer their ISI. After the Lister provides the information about the ISI they activate a button that posts their ISI 510 they want to supply, alerting Pre-Dibs Lookers 515 (who had attributes associated with the ISI on their watchlists) and showing them the just-posted ISI for a preset time before the ISI is shown on the map 520 or displayed elsewhere in user interface to the General Public Lookers or Anonymous Lookers (via APIs Maps 220d and Maps 240d). Once a Dibber initiates messaging with Lister, the Lister responds to Dibber 525 via communication APIs such as Messaging 220h, Messaging 240h, SMS 220c, and SMS 240c. Now connected, the Lister and Dibber set or negotiate time/place and other details concerning the pickup 530 of the ISI. Finally, there occurs a physical or non-physical exchange 535 of the ISI before the ISI is removed from the Platform 540 so it's no longer viewable or available on the Platform to anyone that demands (or supplies) that very ISI in the public domain; ISI is made invisible, inactive, and/or unavailable via APIs Maps 220d and Maps 240d or by other methods common in the art; thus, the geographic location or any information about ISI is no longer on the map or Platform. ISI that has been Dibbed is moved into Inactive Inventory. The image of the ISI, general location of an ISI, and other details about the ISI in Inactive Inventory may still be shown but the Dibs button will be inactive. Once a physical or non-physical exchange has taken place the ISI is completely removed from the system. Lastly, regarding the location of the ISI, for safety and security reasons the Lister may choose to only provide the approximate location of the ISI. The Lookers can view the approximate location of the ISI until it is Dibbed, at which time the location of the ISI is revealed to the sole Dibber. In an embodiment, if payment for the Dibs service is required, the location of the ISI (on a map, in written form, or other) may be revealed to the sole Dibber only after the payment transaction is complete. Ways in which the ISI's address, location on map, coordinates, or other information pertaining to the ISI's location is revealed and made available to the Dibber via communication APIs such as Email 220b, Email 240b, SMS 220c, SMS 240c, in-app Messaging 220h, and in-app Messaging 240h, Push Notifications 220a, Push Notifications 240a, or other methods common in the art.

FIG. 4D is a flow diagram of an example embodiment for a Looker. In this embodiment the Looker user type's activity applies to the Admin Interface 300, User Interface 310, Inventory 320, Demander Database 340, and Public Comments 350 as embodied in FIG. 4A. The Looker's intent is to browse for ISI they may end up desiring to go the extra step and Dibs ISI to eventually retrieve. First, the Looker has registered an account and is logged in 600. Lookers may wish to publicly ask or reply to a comment submitted by a Lister 605. The Looker is on the platform affiliated with the ISI Transaction System looking 610 for ISI (using Maps APIs 220d and Maps 240d). Next, the Looker sees ISI they demand 615 before activating the Dibs button 620 to start the process to becoming a Dibber (seeking Full Dibs Functionality). Meanwhile, the Pre-Dibs Looker 515 (mentioned in FIG. 4C) has a preset window of time to claim priority access to the ISI before the Normal Looker. First, the Pre-Dibs Looker must meet all requirements for Pre-Dibs 625 (subscription requirements, membership status, etc.) or they can't do Pre-Dibs 630. If the Pre-Dibs Looker does meet the requirements, they have the opportunity to add attributes 635 associated with ISI they demand to their watchlist, so when or if the ISI becomes available, they are notified before the general Looker public (APIs are used here if necessary for payment processing and search, 640 as well as APIs Maps 220d, Maps 240d, Payment 220e, and Payment 240e). Next, when the ISI becomes available the Pre-Dibs Looker is notified when ISI with attribute on watchlist is submitted 645 (and APIs for communication purposes such as Email 220b, Email 240b, SMS 220c, SMS 240c, Messaging 220h, and Messaging 240h are used) 220b, 220c, 220h, 240b, 240c, 240h). Now the Pre-Dibs Looker has a preset time opportunity to activate Dibs on the ISI 650. Finally, the Pre-Dibs Looker starts the process and becomes a Dibber the moment they activate the Dibs button 620. Now, to receive Full Dibs Functionality the Dibber must simply initiate messaging with the Lister.

Another potential experience to convey is when a Pre-Dibs Looker is physically moving through different neighborhoods or regions (i.e. walking, in an automobile, etc.). Once they cross over into a specific region where ISI is available that relates to an attribute they entered on their watchlist, they may be notified of the existence of that ISI. If the Pre-Dibs Looker is outside of the area that particular ISI is serving—as determined by the Admins in the ISI Transaction System, the Lister when they offered the ISI for sale or donation, or pre-determined by the attribute preferences of the Pre-Dibs Looker, they may not be alerted about the availability of the ISI unless or until they move within the geographic area that qualifies them to Pre-Dibs the ISI or receive alerts about the ISI. The Pre-Dibs Looker may specify in their preferences which areas they are interested in collecting ISI. As they move into another region, their smartphone 272a may recognize that they have moved into a new region that qualifies them for specific ISI that associates with attributes on their Pre-Dibs watchlist, at which time they will be alerted of that ISI.

FIG. 4E is a flow diagram of an example embodiment for a Dibber. In this embodiment the Dibber user type's activity applies to the Admin Interface 300, User Interface 310, Inventory 320, Supplier Database 330, and Demander Database 340 as embodied in FIG. 4A. The Dibber's intent is to go through the process to eventually receive Full Dibs Functionality to the method that grants them priority access to the location of ISI on a map or in written form as well as exclusive communication privileges with the Lister or entity that offers the ISI for sale or donation. First, the Dibber has registered an account and is logged in 700 or else they must create a new account and log in 705. Just a Looker or Pre-Dibs Looker a moment ago, the Dibber activates the Dibs Button 700. Next the Dibber—early in the process and hasn't yet earned Full Dibs Functionality—must contact (using APIs for communication purposes such as Email 220b, Email 240b, SMS 220c, SMS 240c, Messaging 220h, and Messaging 240h) the Lister within a preset time frame 710. If they fail to message the Lister or appropriate entity within required time limit they lose their Dibs 715 and the ISI returns to Active Inventory 720, viewable again to the public on a map (via APIs Maps 220d and Maps 240d) or in another form. Seeking priority access to the ISI's location and exclusive communication with the ISI's Lister 725 the Dibber successfully contacts the Lister within a preset time frame 730; for example the Dibber messages the Lister within a requirement of 30 minutes (set and monitored by the ISI Transaction System) after activating the Dibs button. The Dibber may unDibs ISI—or deactivate the Dibs button and give up their claim to the priority access to ISI and exclusive communication with the Lister, after Dibbing ISI before or after contact to abandon the Dibs Process 735, which makes the ISI available again to the General Public as it returns to Active Inventory. When the ISI was Dibbed it was moved from Active Inventory to Inactive Inventory. In Inactive Inventory the ISI, while still visible to Lookers, has its Dibs button inactivated. After the Dibber first gets in contact with the Lister or entity attached to the Dibbed ISI, they may set or negotiate a pickup time and/or place 740 so the Dibber may know when and how it is best to retrieve the ISI. Finally, a physical or non-physical exchange of ISI occurs 745 before the ISI is removed from the Platform 750, viewable to the Looker public (via APIs Maps 220d and Maps 240d). It is possible that after the Dibber successfully initiates contact with the Lister during the “Pre-FDF Commit” phase (FDF means Full Dibs Functionality), they may also encounter a secondary time-limit phase during which they'd have to retrieve the ISI before a countdown clock or timer expires. Otherwise the NI may return to Active Inventory and have its Dibs button reactivated and other features viewable to the General Public. When listing ISI it may be up to the Lister how they'd prefer the transaction to play out with a secondary time limit for Dibber or not. There also exists the Dibs Lite button 755, which works like the Dibs button without the communication component. If Listers choose to List ISI that is unattended (or “Unattended ISI”) by them (i.e. on the curb, outside, out of their hands 760) and do not want to converse with a Dibber, they may do so with the Dibs Lite button. The only difference between a Normal Dibs Process and Dibs Lite Dibs Process is that the Dibs Lite Dibber can't get exclusive messaging with the Lister or entity associated with specific ISI. Once Dibs Lite is activated, the Dibs Lite Dibber may retrieve the ISI 745 before the ISI is removed from the Platform 750

FIG. 4F is a flow diagram of an example embodiment for a Physical Dibs Dibber. In this embodiment the Physical Dibs Dibber user type's activity applies to the Admin Interface 300, User Interface 310, Inventory 320, Supplier Database 330, and Demander Database 340 as embodied in FIG. 4A. The Physical Dibs Dibber's intent is to go through the Dibs Process to eventually receive Full Dibs Functionality to the method that grants them priority access to the location of ISI on a map or in written form as well as exclusive communication privileges with the Lister or entity that offers the ISI for sale or donation. Unlike the Normal Dibs, they may activate a Physical Dibs button by pressing with their hands or by hovering their smartphone over the button to give out a code or print a ticket/receipt 870, physically exchange ISI with identification at the location of the Physical Dibs button 875, and/or receive a message with information 880 or further instructions. First, the Physical Dibs Dibber has registered an account and is logged in 800 or else they must create a new account and log in 805. Just a Looker or Pre-Dibs Physical Looker a moment ago, they activate the Physical Dibs button and become a Physical Dibs Dibber. Next the Physical Dibs Dibber—early in the process and hasn't yet earned full Physical Dibs functionality—must contact (using APIs for communication purposes such as Email 220b, Email 240b, SMS 220c, SMS 240c, Messaging 220h, and Messaging 240h) the Lister within a preset time frame 810. If they fail to message the Lister or appropriate entity within required time limit they lose their Physical Dibs 815 and the ISI returns to Active Inventory 820, viewable again to the public on a map (via APIs Maps 220d and Maps 240d) or in another form and with its Dibs button reactivated. Seeking priority access to the ISI's location and exclusive communication with the ISI's Lister 825 the Physical Dibs Dibber successfully contacts the Lister within a preset time frame 830; for example the Physical Dibs Dibber messages the Lister within a requirement of 30 minutes (set and monitored by the ISI Transaction System) after activating the Physical Dibs button. The Physical Dibs Dibber may unDibs ISI after Dibbing ISI before or after contact to abandon the Dibs Process 835. If this happens the ISI is returned to Active Inventory. After the Physical Dibs Dibber first gets in contact with the Lister or entity attached to the Dibbed ISI, they may set or negotiate a pickup time and/or place 840 so the Physical Dibs Dibber may know when and how it is best to retrieve the ISI. Finally, a physical or non-physical exchange of ISI occurs 845 before the ISI is removed from the Platform 850, viewable to the Looker public (via APIs Maps 220d and Maps 240d). It is possible that after the Physical Dibs Dibber successfully initiates contact with the Lister during the “Pre-FDF Commit” phase, they may also encounter a secondary time-limit phase during which they'd have to retrieve the ISI before a countdown clock or timer expires. Otherwise the ISI may return to Active Inventory and have its Dibs button reactivated and other features viewable to the General Public. When listing ISI it may be up to the Lister how they'd prefer the transaction to play out with a secondary time limit for the Physical Dibs Dibber or not. There also exists the Physical Dibs Lite button 855, which works like the Physical Dibs button without the communication component. If Listers choose to List Unattended ISI (i.e. on the curb, outside, out of their hands) 860 and do not want to converse with a Physical Dibs Dibber, they may do so with the Physical Dibs Lite button. The only difference between a normal Physical Dibs and Physical Dibs Lite is that the Physical Dibs Lite Dibber can't get exclusive messaging with the Lister or entity associated with specific ISI. Once Dibs Lite is activated, the Dibs Lite Dibber may retrieve the ISI 845 before the ISI is removed from the Platform 850. Lastly, the Pre-Dibs Physical Looker is like the normal Pre-Dibs Looker but with a Physical Dibs button and has a preset time opportunity to activate the Physical Dibs on the ISI 515 (as noted in the top-left of FIG. 4F); just before the moment they start the process to becoming a Physical Dibs Dibber, the Pre-Dibs Physical Looker activates the Dibs button 800.

FIG. 4G is a flow diagram of an example embodiment for an Admin. In this embodiment the Admin user type's activity applies to the Admin Interface 300, User Interface 310, Inventory 320, Supplier Database 330, Demander Database 340, and Public Comments 350 as embodied in FIG. 4A. The Admin's intent is to oversee and regulate the operations and users within the ISI Transaction System. For example, using the Admin Panel 900 an Admin can see a table of all posted and past ISI including the history and metadata for the ISI (who posted, when posted, who Dibbed, when ISI was Dibbed, when listed as picked up, etc.) 905. They may also receive user feedback in the form of messages or see ISI flagged by users who wanted to call out content that might be a problem 910. Additionally, the Admin has the ability to perform system-wide management actions on posted ISI including removing ISI from public view (using APIs Maps 220d and Maps 240d and other APIs), deleting ISI, and flagging ISI 915. The Admin can view a table of registered users 920 and their information associated with their account within the NI Transaction System. Lastly, the Admin has the ability to perform user account management, or actions on user accounts 925 including sending a private message (using APIs for communication purposes such as Email 220b, Email 240b, SMS 220c, SMS 240c, Messaging 220h, and Messaging 240h), suspending a user, unsuspending a user, deleting a user, manually resetting password of user, make notes about user only visible to other Admins (for use in recording abuse, flagged ISI, etc.), and view the history of a user (i.e. past and present Dibs and Listings).

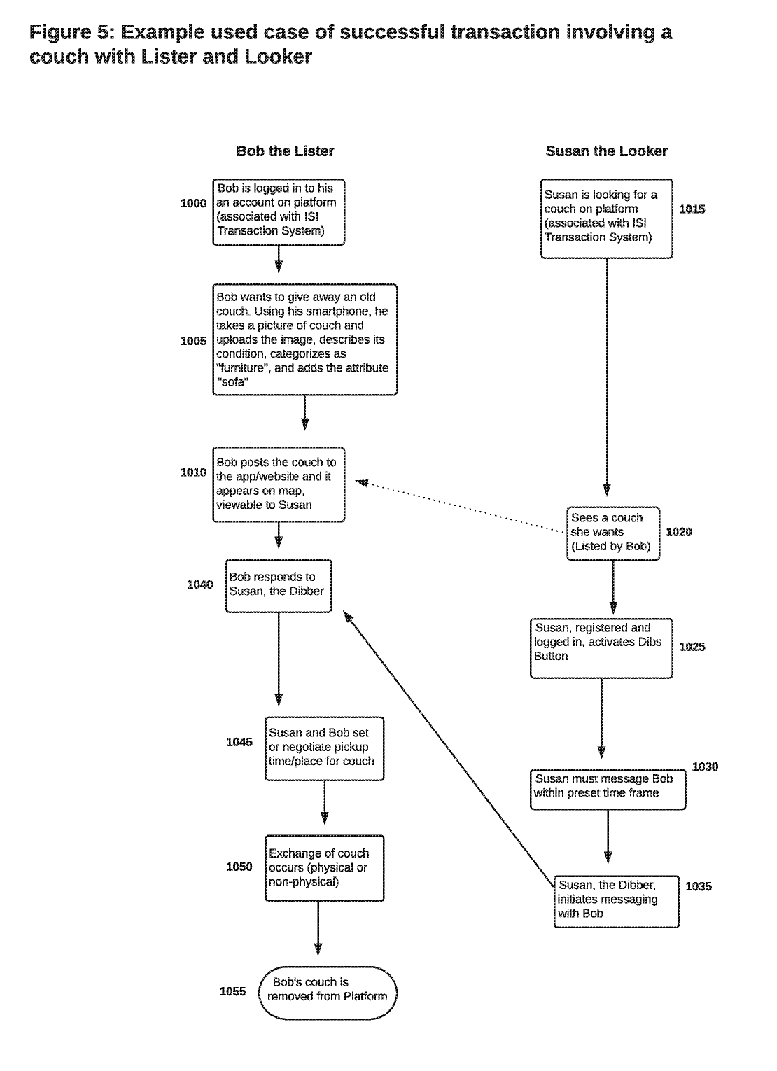

FIG. 5 is a flow diagram of an example embodiment that depicts an example successful transaction involving a couch between Bob, the Lister, and Susan, the Looker. In this example, Bob wants to give away his old couch and Susan wants a couch for her new apartment. First, Bob is logged in to his account on Platform associated with ISI Transaction System 1000. Bob wants to give away an old couch so he takes a picture of his couch with his smartphone and uploads the image, describes its condition, categorizes as “furniture”, and adds another attribute “sofa” 1005. Next, Bob posts the couch to the app/website and it appears on the Platform's map, viewable to Susan and other lookers 1010. Meanwhile, Susan is looking for a couch on the platform associated with the ISI Transaction System 1015 right about the same time Bob listed his couch, and Susan sees a couch she wants (Bob's couch) 1020. Susan, registered and logged in, activates the Dibs button 1025. At this time Bob's couch is moved from Active Inventory to Inactive Inventory. Though the image of the couch and other details about the couch may still be accessible to other Lookers the Dibs button would be inactivated. She interprets that she must message Bob within preset time frame 1030 (in order to get Full Dibs Functionality and prove to Bob she isn't a flake) so Susan, now the Dibber, initiates messaging with Bob 1035. Bob replies to Susan 1040 and they communicate and set up or negotiate a pickup time and/or place 1045. Finally, a physical or non-physical exchange of the couch occurs 1050 before Bob's couch is removed from the Platform 1055.

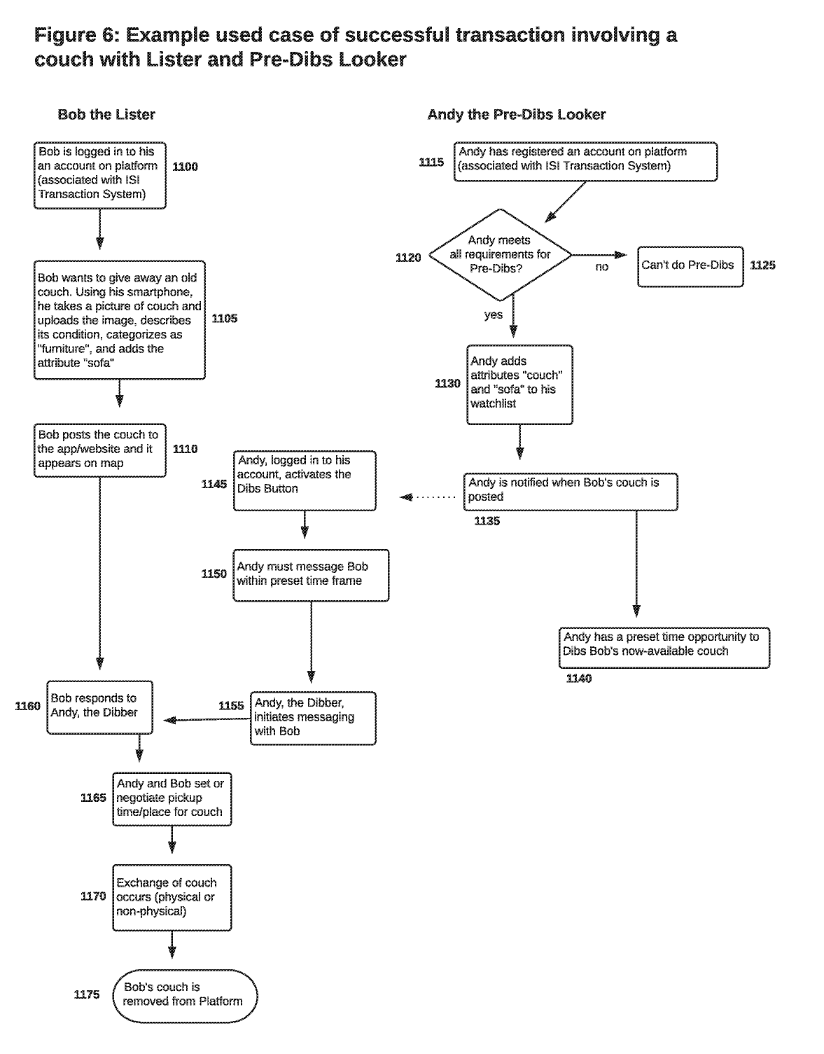

FIG. 6 is a flow diagram of an example embodiment which depicts an example successful transaction involving a couch between Bob, the Lister, and Andy, the Pre-Dibs Looker. In this example, Bob wants to give away his old couch and Andy wants a couch for his new house. First, Bob is logged in to his account on platform associated with ISI Transaction System 1100. Bob wants to give away an old couch so he takes a picture of his couch with his smartphone and uploads the image, describes its condition, categorized as “furniture”, and adds another attribute “sofa” 1105. Next, Bob posts the couch to the app/website and it appears on the Platform's map in Pre-Dibs Active Inventory 1110, viewable to Pre-Dibs Lookers who had an attribute associated with Bob's couch on their watchlist (for a preset time frame of 10 minutes, for example) before it's moved to Active Inventory viewable to all Lookers. Yesterday, Andy was looking for a couch on the platform associated with the ISI Transaction System 1115. When he couldn't find a couch he wanted he discovered that he could Pre-Dibs ISI. Andy had to meet all the requirements for Pre-Dibs 1120 (or else he couldn't participate in Pre-Dibs 1125), and he saw he had to make an account and log in. After making an account Andy went to his watchlist and added the attributes “couch” and “sofa” 1130. Andy added the attributes, or keywords “couch” and “sofa” into a text box or multiple boxes before submitting them to the Platform by clicking a button with his computer mouse (i.e. when using a personal computer such as his laptop computer or desktop computer) or by tapping a button with his finger (i.e. when using a smartphone or tablet) to indicate to the Platform he has finished entering and committing the attributes about ISI that he wants to know about and be informed if that ISI becomes available. The attributes are stored in the Inventory Database, or inside another database within the Collection of In-House 222 or Third-Party 242 Computer Systems and Databases, or within the System of Personal Network Devices 272. In another example embodiment, there exists the opportunity to choose and submit pre-selected ISI attributes. For example, when Andy first entered his attribute “couch”, the watchlist generated other suggested keywords he might want to submit, and he noticed that the Platform suggested “sofa”, which is similar to the concept couch. Instead of having to think to submit “sofa” himself, the Platform thought of “sofa” for Andy (via software algorithm) when he submitted “couch” into his watchlist's attribute list. Andy then clicked a button with his computer mouse (i.e. when using a personal computer such as his laptop computer or desktop computer) or he tapped a button with his finger (i.e. when using a smartphone or tablet) to indicate to the Platform he wanted to select the suggested pre-selected ISI attribute “sofa”, which was committed to his attribute watchlist; other methods common in the art may be implemented to select, pre-select, store, commit, and suggest attributes. The information pertaining to the watchlist may be stored on Andy's device in a method known as caching, or via other methods common in the art. The next day, the event of Bob posting his couch (and adding attribute “sofa” and “couch”) triggered Andy's watchlist and Andy is notified that Bob's couch is available 1135. Andy gets a message (i.e. push notification, email, etc.) alerting him that he has a preset time opportunity to activate Dibs on Bob's now-available couch 1140 so Andy launches the website or Platform associated with the ISI Transaction System, logs into his account, and activates the Dibs button 1145. Andy interprets that he must now message Bob within preset time frame 1150 (in order to get Full Dibs Functionality and prove to Bob he isn't a flake) so Andy, now the Dibber, initiates a conversation with Bob 1155 by sending him an in-app message. Bob replies to Andy 1160 and they communicate and set up or negotiate a pickup time and/or place 1165. Finally, a physical or non-physical exchange of the couch occurs 1170 before Bob's couch is removed from the Platform 1175.

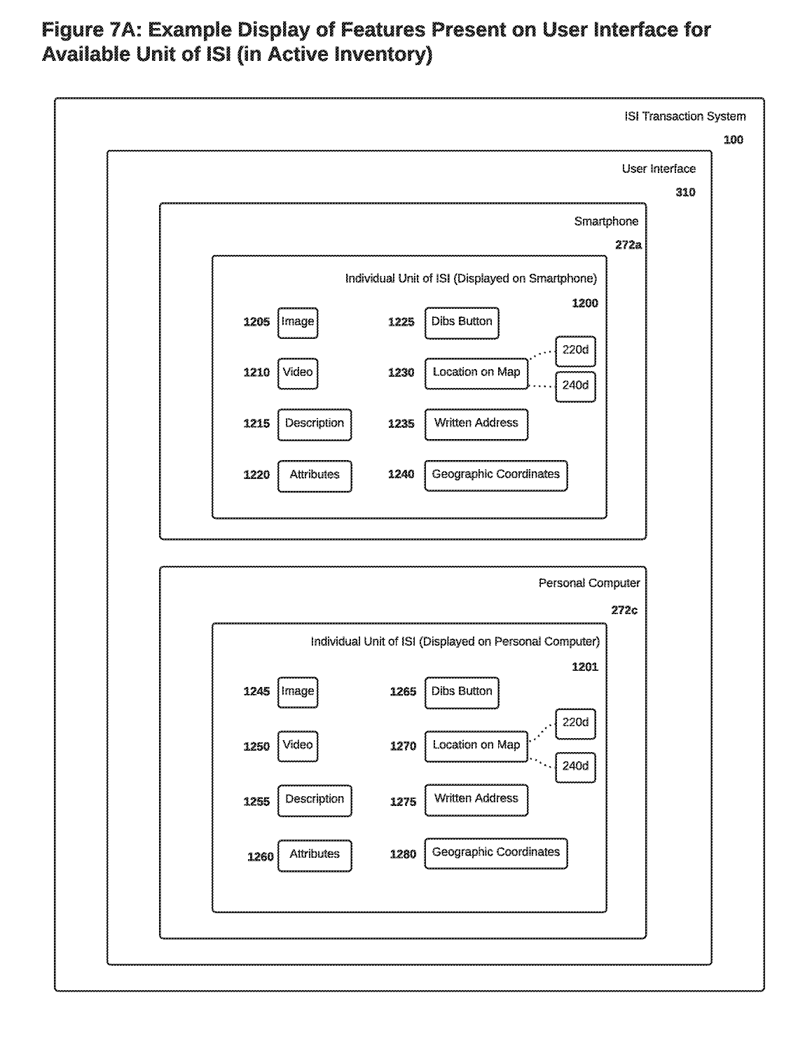

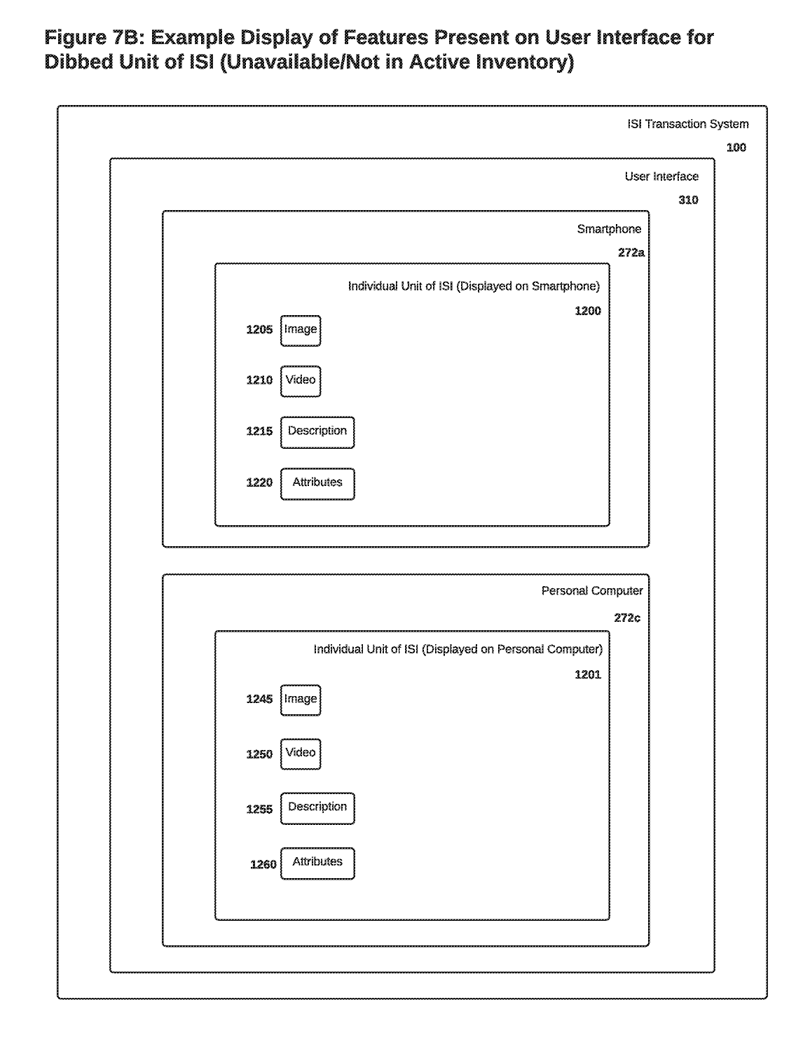

FIG. 7A illustrates an example embodiment of an individual unit of available ISI's present features that are displayed on the user interface of a smartphone connected to the ISI Transaction System and a personal computer connected to the ISI Transaction System. FIG. 7B references back to FIG. 7A and illustrates an example embodiment of an individual unit of Dibbed (unavailable) ISI's present features that are displayed on the user interface of a smartphone connected to the ISI Transaction System and a personal computer connected to the ISI Transaction System. In an example embodiment depicted in FIG. 7A the Individual Unit of ISI (Displayed on Smartphone) 1200 is shown to the user (i.e. Looker, Anonymous Looker, Physical Dibs Looker, Pre-Dibs Looker, or other) on a Smartphone 272a. There is also the Individual Unit of ISI (Displayed on Personal Computer) 1201 that is shown to the user (i.e. Looker, Anonymous Looker, Physical Dibs Looker, Pre-Dibs Looker, or other) on a Personal Computer 272c. The Smartphone 272a and Personal Computer 272c are connected to the User Interface 310 of the Platform's mobile application or website, which executes on the ISI Transaction System 100. Within an Individual Unit of ISI (Displayed on Smartphone) 1200 and an Individual Unit of ISI (Displayed on Personal Computer) 1201 a user such as a Looker may browse and discover a particular unit of ISI and see features that describe that ISI. For example, a Looker may see that an Individual Unit of ISI (Displayed on Smartphone) 1200 has the following features: Image 1205, Video 1210, Description 1215, Attributes 1220, Dibs Button 1225, Location on Map 1230 (via APIs Maps 220d and Maps 240d), Written Address 1235, and Geographic Coordinates 1240. A Looker may also see that an Individual Unit of ISI (Displayed on Personal Computer) 1201 has the following features: Image 1245, Video 1250, Description 1255, Attributes 1260, Dibs Button 1265, Location on Map 1270, Written Address 1275, and Geographic Coordinates 1280. A Looker or any user type who visits the Platform to look for ISI that they demand will see the features just mentioned present on available ISI, or ISI that is in Active Inventory. ISI that is available and considered to be in Active Inventory specifically has the Dibs Button 1225, Location on Map 1230, Written Address 1235, and Geographic Coordinates 1240 and the Dibs Button 1265, Location on Map 1270, Written Address 1275, and Geographic Coordinates 1280, as well as other information that is relevant to the Dibs Process.

FIG. 7B illustrates an example embodiment of what the Individual Unit of ISI (Displayed on Smartphone) 1200 and the Individual Unit of ISI (Displayed on Personal Computer) 1201 looks like when that individual unit of ISI is Dibbed, or unavailable (i.e. not considered to be in Active Inventory). Notice on the Individual Unit of ISI (Displayed on Smartphone) 1200 that the Dibs Button 1225, Location on Map 1230, Written Address 1235, and Geographic Coordinates 1240 are not visible or shown to the Looker. Also notice on the Individual Unit of ISI (Displayed on Personal Computer) 1201 that the Dibs Button 1265, Location on Map 1270, Written Address 1275, and Geographic Coordinates 1280 are not visible or shown to the Looker. This is because once a unit of ISI has been Dibbed, that ISI has been removed from Active Inventory and placed in Inactive Inventory, and it is the sole Dibber, besides the Lister, who retains all the information, rewards, and benefits that are communicated through the features such as the Dibs Button 1225, Location on Map 1230, Written Address 1235, and Geographic Coordinates 1240, Dibs Button 1265, Location on Map 1270, Written Address 1275, and Geographic Coordinates 1280. Lookers are motivated to activate the Dibs button on ISI and become Dibbers themselves so they have priority access to such features mentioned, as well as exclusive communication with the Lister. In another embodiment, depending on the Admin's discretion, it is also possible that the ISI will be absent from the view of the Looker entirely when that ISI is Dibbed during the Dibs Process. For example, when an ISI is Dibbed, everything pertaining to the existence of that ISI on the Platform may not be visible to anyone except the Dibber or Lister, which includes the Image 1245, Video 1250, Description 1255, Attributes 1260 in the Individual Unit of ISI (Displayed on Smartphone) 1200, and the Image 1245, Video 1250, Description 1255, Attributes 1260 in the Individual Unit of ISI (Displayed on Personal Computer) 1201. However, a motivational reason for the Admin of the Platform to not have the ISI removed entirely from view (such as in a list format) during the Dibs Process is to create further demand for that ISI. This way, if the Dibber turns out to be a flake by failing to exchange the ISI during the Secondary Time Limit Phase the Lister may have other Lookers lining up to activate Dibs on their ISI when they get an opportunity when the ISI returns to Active Inventory. The Lookers who could not see the exclusive information such as the Dibs Button, Location on Map, Written Address, and Geographic Coordinates could still see the ISI's Image, Video, Description, and attributes on a list. They could also ask the Lister public questions through the Public Comments interface. The Lister intends to exchange their ISI with the Dibber of their ISI but if the Dibber flakes they have other Lookers ready to Activate Dibs on their ISI because they still saw that the ISI existed, even if they didn't see information about where the ISI is located or other exclusive, more valuable information about the ISI.

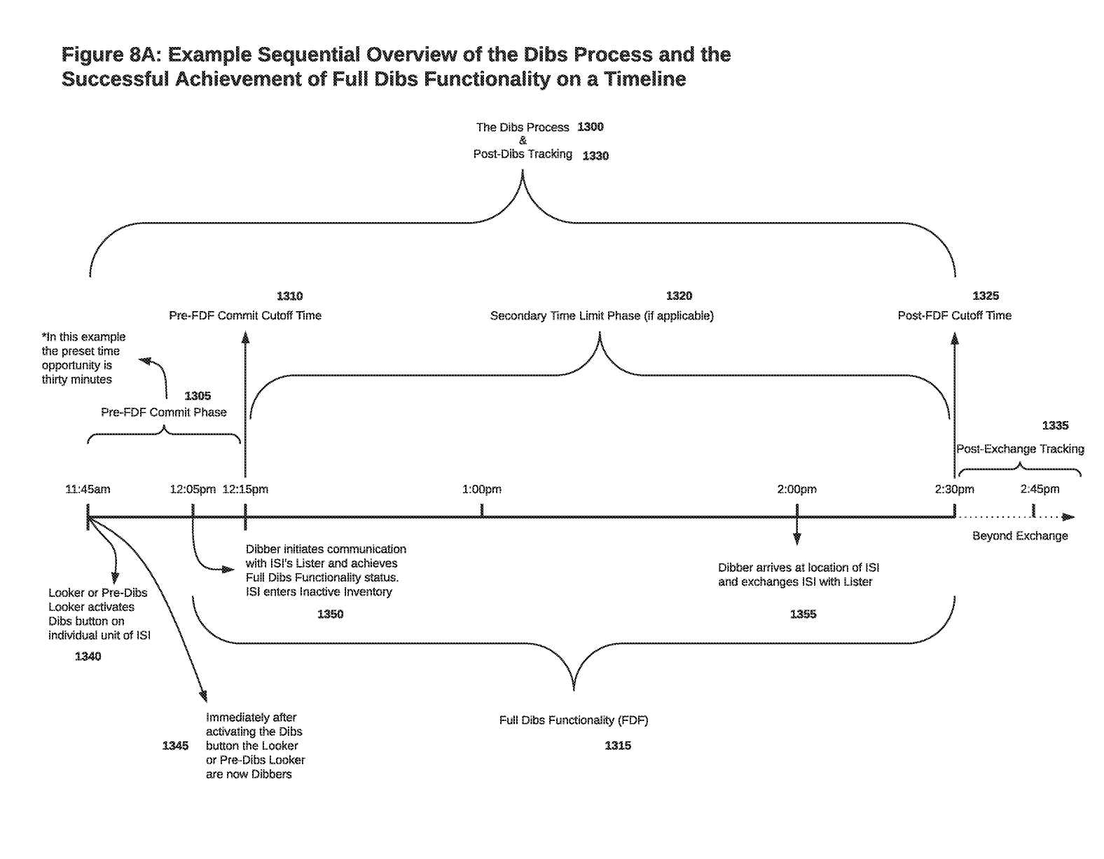

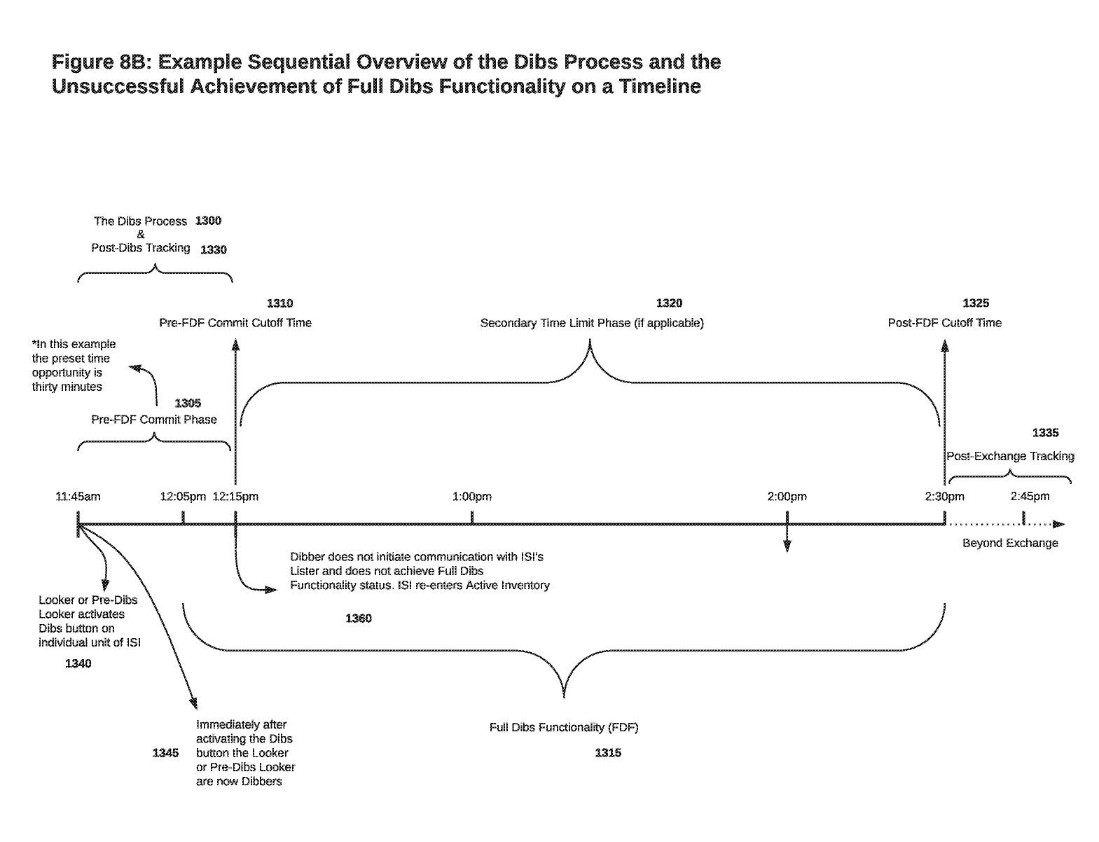

FIG. 8A illustrates an example embodiment of a sequential overview of the Dibs Process and the successful achievement of Full Dibs Functionality on a timeline between the events of activating the Dibs Button on an individual unit of ISI 1340 and the removal of that ISI from Active Inventory (the Post-FDF Cutoff Time 1325). In an example embodiment there is a timeline that ranges from 11:45 am to 2:30 pm, and beyond 2:30 pm. The Dibs Process 1300 encompasses everything that happens between the activation of the Dibs button 1340 and the Post-FDF Cutoff Time 1325. In this example embodiment the preset time opportunity is thirty minutes, which is the same as saying the Pre-FDF Commit Phase 1305 lasts for thirty minutes after the activation of the Dibs Button. The Pre-FDF Commit Phase 1305, also known as the “Pre-FDF Commit” is the window of time that occurs between the activation of the Dibs button 1340 and the Pre-FDF Commit Cutoff Time 1310. The Dibber's goal is to achieve Full Dibs Functionality, or “FDF” 1315, which is the status that a Dibber seeks after activating the Dibs button. Once the Dibs button is activated, the Dibber must proceed with their responsibility to message or contact the Lister in order to secure the rest of their Dibs privileges, and achieve their Full Dibs Functionality 1315. Moreover, once the Dibs button is activated a Dibber has a preset time opportunity, also known as the Pre-FDF Commit Phase 1305, to initiate communication with the Lister of the ISI that they Dibbed. The Dibber achieves FDF the instant they initiate communication with the Lister via in-app messaging, for example. The Dibber seeks FDF and is motivated to initiate messaging before the Pre-FDF Commit Cutoff time 1310 or else they lose their privilege to Dibs that specific ISI. If the Dibber fails to initiate messaging or communication with the Lister and achieve FDF before their preset time opportunity (or Pre-FDF Commit Cutoff) expires 1310, they forfeit their opportunity to seek Full Dibs Functionality. If Dibber doesn't initiate communication with Lister of ISI before the Pre-FDF Commit Cutoff, the ISI and the ISI's respective Dibs button, location, and other exclusive information re-enter Active Inventory; if the ISI re-enters Active Inventory then the other Lookers and General Public can once again view and activate Dibs on that ISI. Full Dibs Functionality 1315 happens between the time a Dibber initiates communication with the ISI's Lister and achieves the FDF status (at which time ISI enters Inactive Inventory) 1350 and the Post-FDF Cutoff Time 1325, or at a sooner time when the Dibber exchanges the ISI with Lister 1355. If Dibber fails to initiate messaging with Lister during the Pre-FDF Commit Phase 1305, the Dibber loses their Dibs privilege and the ISI they Dibbed returns to Active Inventory. The Pre-FDF Commit Cutoff Time 1310, also known as the “Pre-FDF Cutoff”, is the instant in time that affords the Dibber Full Dibs Functionality 1315 if the Dibber qualifies. Or, if the Dibber failed to initiate communication with the Lister during the Pre-FDF Commit Phase 1305 before the Pre-FDF Cutoff time 1310, the Dibber loses their Dibs privilege and the ISI they Dibbed returns to Active Inventory. The Pre-FDF Cutoff 1310 is a cutoff time imposed and required by the ISI Transaction System with the intent of motivating the Dibber to prove they are interested in completing the transaction and exchange of ISI. It's a precaution the ISI Transaction System takes to vet out potential flakes, or users who don't take the transactions seriously. If the Dibber successfully initiates communication with the Lister before the Pre-FDF Commit Cutoff Time 1310 then the Dibber may enter the Secondary Time Limit Phase 1320, which concludes when the ISI is exchanged or at the Post-FDF Cutoff Time 1325. The Secondary Time Limit Phase 1320 or “Secondary Time Limit”, describes the window of time and opportunity—afforded to the Dibber who achieves Full Dibs Functionality 1315—between the Pre-FDF Cutoff 1310 moment and the moment the exchange of ISI occurs 1355, between Dibber and Lister. FDF 1315 exists within the definition of Secondary Time Limit Phase 1320 but also includes the extra time the Dibber is afforded between the moment the Dibber initiates communication with the Lister 1350 and the Pre-FDF Cutoff Time 1310. The Secondary Time Limit Phase's 1320 duration may be indefinite or have a Post-FDF Cutoff Time 1325, which marks a point in time by when a Dibber must exchange the ISI with the Lister. The Post-FDF Cutoff Time's 1325 implementation or applicability may be determined by the Admin, and the Lister may suggest or set a window of time and Post-FDF Cutoff Time 1325 that the Dibber has to operate within. The Post-FDF Cutoff Time 1325, or “Post-FDF Cutoff”, marks the point in time by when a Dibber (who has achieved Full Dibs Functionality) must exchange the ISI with the Lister (or be branded a flake) and lose their Full Dibs Functionality. The Post-FDF Cutoff Time 1325 concludes the Secondary Time Limit Phase 1320. On the timeline Post-Dibs Tracking 1330 is shown, which is the ISI Transaction System's automated tracking that occurs between the time when the user activates the Dibs button 1340 and the Post-FDF Cutoff Time 1325, when the ISI is exchanged. The ISI Transaction System communicates with the Lister and Dibber by sending them push notifications, in-app messages, or other methods common in the art that enable the Platform to confirm if the ISI has been exchanged. Post-Dibs Tracking 1330 is also used to study the behavior of the Lister and Dibber in each ISI transaction after the activation of the Dibs button 1340 to better learn how to make improvements to the Platform. Another variant of tracking that is used is Post-Exchange Tracking 1335, which is the ISI Transaction System's automated tracking that occurs between the Post-FDF Cutoff Time 1325, when the ISI is exchanged between the Lister and Dibber, and indefinitely into the future. The ISI Transaction System communicates with the Lister and Dibber by sending them push notifications, in-app messages, or other methods common in the art that enable the Platform to confirm if the ISI has been exchanged. After the exchange occurs, the Platform may continue to send push notifications, in-app messages, or other methods common in the art that enable the Platform more opportunities to confirm if the ISI has been exchanged, why it was not exchanged, or probe the Lister and Dibber for information regarding their transaction. Post-Exchange Tracking 1335 is also used to study the behavior of the Lister and Dibber in each ISI transaction after the Post-FDF Cutoff Time 1325 to better learn how to make improvements to the Platform.

FIG. 8A further illustrates an example successful achievement of FDF by a Looker or Pre-Dibs Looker who, at 11:45 am, activates the Dibs button on an individual unit of ISI 1340. Immediately after activating the Dibs button the Looker or Pre-Dibs Looker are now Dibbers 1345. In this example embodiment the Pre-FDF Commit Phase 1305 lasts for thirty minutes and the Dibber has until 12:15 pm, which is the Pre-FDF Commit Cutoff Time 1310 to initiate communication with the Lister to achieve Full Dibs Functionality 1315. At 12:05 pm the Dibber initiates communication with ISI's Lister and achieves Full Dibs Functionality status 1350. The Lister indicated to the ISI Transaction System (and Dibber) when they listed their ISI that the Dibber has until 2:30 pm to exchange the ISI (or the ISI returns to Active Inventory and Dibber loses their priority access to ISI and exclusive communication with Lister). The Dibber acknowledges that they must coordinate the exchange of the ISI with the Lister and eventually exchange the ISI by 2:30 pm, the time mandated by the Lister, which is also the Post-FDF Cutoff Time 1325. To play it safe and not wait until the last minute, the Dibber arrives at the location of ISI and successfully exchanges ISI with Lister 1355. The Dibber has Full Dibs Functionality 1315 up until 2:30 pm, the Post-FDF Cutoff Time 1325, and must exchange the ISI by 2:30 pm. If the Dibber fails to exchange ISI after they commit to exchanging the ISI the user is labeled a “flake” and may suffer consequences. For example, they may be shamed by having a picture of a snowflake or token attached to their account profile to warn other Listers that this Dibber wasn't accountable in the past. A flake is someone who commits to getting ISI but never shows up to pick up or exchange the ISI. For example, they may activate the Dibs button on ISI and/or message the Lister to coordinate the exchange of the ISI, but they never show up to pick up the ISI. In this situation, the fault rests with the Dibber, who is considered a flake. Using as a verb, the Dibber is considered to have flaked out. The Dibber who achieves Full Dibs Functionality status is considered a flake if they fail to exchange the ISI with the Lister during the Secondary Time Limit Phase. If the ISI Transaction System brands a Dibber who flaked “a flake” the Lister may have the option to vouch for the Dibber (after the Post-FDF Cutoff Time) and help remove the flake attribution status. This may be part of the Post-Exchange Tracking 1335.

FIG. 8B references back to FIG. 8A and illustrates an example embodiment of a sequential overview of the fibs Process and the unsuccessful achievement of Full Dibs Functionality on a timeline between the events of activating the Dibs Button on an individual unit of ISI and the re-entry of that ISI back into Active Inventory (the Post-FDF Cutoff Time 1325). In an example embodiment, at 11:45 am the Looker or Pre-Dibs Looker activates the Dibs button on individual unit of ISI 1340. Immediately after activating the Dibs button the Looker or Pre-Dibs Looker are now Dibbers 1345. In this example embodiment the Pre-FDF Commit Phase 1305 lasts for thirty minutes and the Dibber has until 12:15 pm, which is the Pre-FDF Commit Cutoff Time 1310 to initiate communication with the Lister to achieve Full Dibs Functionality 1315. By 12:15 pm it is determined by the ISI Transaction System that the Dibber does not initiate (never initiated) communication with the ISI's Lister and does not achieve Full Dibs Functionality status. ISI re-enters Active Inventory 1360. Therefore, the Dibber is no longer a Dibber and the ISI that was Dibbed re-enters Active Inventory so other Lookers may activate Dibs on the now-available ISI. The Secondary Time Limit Phase 1320 does not apply to this transaction, nor do the other ensuing phases after the Pre-FDF Commit Cutoff Time 1310 after it is determined by the Platform that a Dibber failed to initiate communication with the Lister when they had the opportunity during the Pre-FDF Commit Phase 1305. Thus, the Dibs Process 1300 ends for this transaction at 12:15 pm at the FDF Commit Cutoff Time 1310 when it is determined by the Platform that the Dibber failed to initiate communication with the Lister when they had the opportunity during the Pre-FDF Commit Phase 1305.

What is claimed is:

1. A system of locating, communicating, and prioritizing private party, company, partnership, corporation or other entity's transactions involving Goods, Services, or Information about Goods or Services comprising:
one or more in-house processing systems and databases;
one or more third party processing systems and databases;
one or more APIs that are stored in and accessible through the one or more in-house processing systems and databases and the one or more third party processing system and databases;
a network having remote servers hosted on the Internet used to store, manage, and process data in place of local servers or personal computers, the network interchanges where ISI data flows between the one or more in-house processing systems and databases and the one or more third party processing system and databases;
a system of personal network devices and databases in communication with the one or more in-house processing systems and databases and the one or more third party processing system and databases via the network;
one or more virtual Dibs each having a Dibs button, the one or more virtual Dibs claiming a priority right to a Good or Service or Information about a Good or Service;
one or more virtual Dibs having exclusive communication with an owner of the Good or Service or Information about a Good or Service via the network;
one or more external ISI marketplaces operated by Users that automatically obtain and use information related to one or more users of an overall system stored on the ISI marketplaces; and
a system of personal network devices and databases in communication with the one or more in-house processing systems and databases and the one or more third party processing system and databases via the network.

2. The system according to claim 1, further comprising one or more Physical Dibs, the one or more Physical Dibs claiming a priority right to a Good or Service or Information about the Good or Service, as well as exclusive communication with an owner of the Good or Service or Information about the Good or Service via the network.

3. The system according to claim 1, wherein the in-house processing systems and databases comprise an admin interface, a user interface each accessing an inventory database, a supplier database, a demander database, and a public comments database.

4. The system according to claim 1, further comprising a payment processing service that processes indicated payments on request to and from one or more users.

5. The system according to claim 1, further comprising a system of personal network devices and databases that comprises smart phones, tablets, personal computers, printers, fax machines, scanners, vehicles, wearables and connected Internet of things.

6. The system according to claim 1, further comprising a user interface displaying ISI inventory in various states, comprising Active Inventory and Inactive Inventory.

7. The system according to claim 1, further comprising a user interface displaying ISI inventory in various states, comprising Pre-Dibs Active Inventory and Pre-Dibs Inactive Inventory.

8. The system according to claim 1, wherein the features present on a user interface include, but are not limited to, an image, a video, a description, attributes relating to an ISI, one of the Dibs buttons, a location on one of the maps, a written address, and geographic coordinates.

9. The system according to claim 1 wherein the service comprises an exchange of pleasure from laughs or exotic acting.

10. The system according to claim 1, wherein the one or more APIs comprise: push notifications, Email, SMS, maps, payment, voice, VoIP, messaging, MMS, and NFC.

11. The system according to claim 1, wherein one or more users lock in a particular price on a specific, identifiable, ISI by Dibbing and the ISI is then removed from the marketplace or the ISI's Dibs button is inactivated. If notification of exchange is not received the ISI would be returned to the marketplace and/or the ISI's Dibs button reactivated.

12. The system according to claim 1 further comprising sharing of opportunities to provide particular ISI with particular users in such a way as to balance the supply and demand of the ISI.

13. The system according to claim 2 wherein the Physical Dibs button is hidden in the physical world and once found and activated gives access to ISI or priority information.

14. A method for locating, communicating, and prioritizing private party transactions involving Goods, Services, or Information about Goods or Services comprising the steps of:
having a Lister register and logged into an account with a system of locating, communicating, and prioritizing private party transactions involving Goods, Services, or Information about Goods or Services;
wherein the Lister posts an ISI on a website or an app associated with the system of locating, communicating, and prioritizing private party transactions involving Goods, Services, or Information about Goods or Services;
having a registered Looker or Pre-Dibs Looker see the ISI that appears on the website or app associated with the system of locating, communicating, and prioritizing private party transactions involving Goods, Services, or Information about Goods or Services, and activates a Dibs button;
removing the ISI from the marketplace or inactivating the Dibs button associated with the ISI unless confirmation of physical or non-physical exchange is not received by the system in a set amount of time;
if confirmation of physical or non-physical exchange is not received by the system in a set amount of time the ISI would be returned to the marketplace and/or the Dibs button associated with the ISI reactivated;
having the registered Lister respond to the Dib from the activated Dibs button and negotiate or set a pickup time and place from a map or user interface from the Web site or App; and
exchanging ISI at the pickup time and place from the map or user interface and removing the exchanged ISI from the Website or App.

15. The method according to claim 14, further comprising the Lister communicating about the ISI.

16. The method according to claim 14, wherein the Pre-Dibs Looker meets a set of Pre-Dibs requirements and adds attributes of the ISI to a watchlist.

17. The method according to claim 14, wherein the Lookers or the Pre-Dibs Lookers lock in a particular price on a specific, particular, identifiable ISI by Dibbing on the ISI.

18. A non-transitory computer storage media having instructions stored thereon which, when executed, execute a method comprising the steps of:
having a Lister register and logged-into an account with a system of locating, communicating, and prioritizing private party transactions involving Goods, Services, or Information about Goods or Services;
posting an ISI on a website or an app of the system of locating, communicating, and prioritizing private party transactions involving Goods, Services, or Information about Goods or Services;
having a registered Looker or Pre-Dibs Looker see the ISI that appears on the website or app associated with the system of locating, communicating, and prioritizing private party transactions involving Goods, Services, or Information about Goods or Services and activate a Dibs button associated with a particular ISI;
removing the Dibbed ISI from the marketplace or inactivating the Dibs button associated with the ISI unless confirmation of physical or non-physical exchange is not received by the system in a set amount of time; if confirmation of physical or non-physical exchange is not received by the system in a set amount of time the ISI would be returned to the marketplace and/or the Dibs button associated with the ISI reactivated;
having the registered Lister respond to the Dibs from the activated Dibs button and negotiate or set a pickup time and place from a map or user interface from the Web site or App; and
exchanging ISI at the pickup time and place from the map or user interface and removing the exchanged ISI from the Website or App.

19. The non-transitory computer storage media according to claim 18, wherein the Pre-Dibs Looker meets Pre-Dibs requirements and adds attributes of the ISI to a watchlist.

20. The non-transitory computer storage media according to claim 18, wherein the Lookers or the Pre-Dibs Lookers lock in a particular price on a specific, particular, identifiable ISI by Dibbing.
